(19) United States
(12) Patent Application Publication
(10) Pub. No.: US 2026/0308782 A1
(43) Pub. Date: Oct. 8, 2026

(54) ELECTRONICALLY CONDUCTIVE POLYMER BINDER FOR COMPOSITE ELECTRODES

(71) Applicant: THE GOVERNORS OF THE UNIVERSITY OF ALBERTA, Edmonton (CA)

(72) Inventors: Jinkun LIU, Edmonton (CA); Steven H. BERGENS, Edmonton (CA)

(73) Assignee: THE GOVERNORS OF THE UNIVERSITY OF ALBERTA, Edmonton, AB (CA)

(21) Appl. No.: 19/481,743

(22) PCT Filed: May 13, 2024
(86) PCT No.: PCT/IB2024/054654

§ 371 Date: Nov. 5, 2025

Related U.S. Application Data
(60) Provisional application No. 63/465,730, filed on May 11, 2023.

(51) Int. Cl. C25B 11/052; C25B 1/04; C25B 11/061; C25B 11/065; C25B 11/085

(52) U.S. Cl. CPC C25B 11/052; C25B 1/04; C25B 11/061; C25B 11/065; C25B 11/085

(57) ABSTRACT

A redox-active, conductive, polycationic, and coordinating polymer with a coordinative redox deposition for oxygen evolution reaction (OER) electrodes. The electrodes can contain low loadings of earth-abundant catalysts and are highly active and stable under harsh conditions. The preparatory methods described herein are straightforward and can be utilized to prepare electrodes with different supports and metal ion precursors. Polycarbazole (PCz) provides a highly conductive, stable support for the OER catalysts. XPS and UV-vis studies indicate that the deposition proceeds by coordination to the nitrogen sites in PCz. PCz is believed to provide a local high [OH—] for the turnover limiting step in the OER.

### RELATED APPLICATIONS

This application claims priority under 35 U.S.C. § 119(e) to U.S. Provisional Patent Application No. 63/465,730, filed May 11, 2023, which is incorporated herein by reference.

### BACKGROUND OF THE INVENTION

The electrolysis of water is the process of using electricity to split water into hydrogen and oxygen. Electrolysis breaks water down into pure hydrogen and pure oxygen. The process is environmentally friendly and does not produce any harmful byproducts. Thus, the use of water to produce energy also provides a raw material (water) that is safe, easy to store and abundant. Unfortunately, current methods of water electrolysis use more energy than it produces. Thus, currently the primary way of producing electricity is through the burning of fossil fuels.

Electrolysis of pure water requires excess energy in the form of overpotential to overcome various activation barriers. Without the excess energy, electrolysis occurs slowly or not at all. This method requires electrodes that convert water into protons, electrons, and oxygen. This is in part due to the limited self-ionization of water due to the fact that pure water is a poor conductor of electricity. Efficiency is increased through the addition of an electrolyte (such as a salt, an acid, or a base) and electrocatalysts. Currently, most electrolyte cations used are Li⁺, Rb⁺, K⁺, Cs⁺, Ba²⁺, Sr²⁺, Ca²⁺, Na⁺, and Mg²⁺. Sodium and lithium are common choices, as they form inexpensive, soluble salts. More recently solid electrolytes such as Nafion can efficiently electrolyze with as little as 1.5 volts. However, Nafion loses stability and still results in an energy barrier to efficient production.

Therefore, more efficient materials and methods are needed to more cheaply and efficiently produce energy from water electrolysis.

### SUMMARY

The inventors have produced a multifunctional polymer that conducts electrons, ions, and may co-react with the metal ions in oxygen evolution reaction (OER). The electrodes were prepared in two steps from off-the-shelf reagents. They operate with low loadings of abundant catalysts and are among the most active (100 mA cm⁻² at 1.43 V vs. RHE (1.41 V, iR corrected)), and stable reported to date under harsh conditions (85° C., 6 M KOH, 120 hours (0.69% loss over the first 14.5 h, then 0.61% loss over 105.5 h)). It is desirable for such electrodes to operate under harsh conditions such a high temperature (>70° C.), high alkalinity (>4 M KOH), or high current density (>100 mA cm⁻²). Control experiments on glassy carbon electrodes showed that the polycarbazole system significantly outperformed a Nafion system of the same catalyst loading. This simple strategy can be applied to other types of electrodes.

Therefore, in various exemplary embodiments, the invention provides an electrode having greater stability for use in oxygen evolution reactions (OER) where the electrode comprises a polycarbazole (PCz) deposited on a conductive substrate. In certain embodiments, the PCz is deposited on a nickel (Ni) foam substrate. In some embodiments, the substrate is carbon fiber. In some embodiments, the formula of the active component comprises the formula MₓFe_{y}-PCZ/CF wherein M is Ni or Co. In various embodiments, the electrode is a glassy carbon electrode. In these exemplary embodiments, the electrode can have a low double-layer capacitance (C_{dl}) and high activity. In various embodiments, the electrode is redox-active, conductive, polycationic and coordinating.

In yet other exemplary embodiments, the invention provides a method for making a high activity, stable OER electrode comprising:
a) depositing a polycarbazole (PCz) layer over a conductive substrate; and
b) depositing an electrocatalyst on the PCz-layered substrate.

In various embodiments, Ni_{foam} is the substrate. In some embodiments, the substrate is carbon fiber. In some embodiments, the deposition is made using electropolymerization. In various embodiments, the electropolymerization is cyclic voltammetry. In some embodiments, the PCz is doped. In some embodiments, the active component comprises MₓFe_{y}-PCz/CF wherein M is Ni or Co. In these embodiments, the active component is deposited from NiCl₂·6H₂O, FeCl₂·4H₂O, or CoCl₂·6H₂O in a solvent. In some embodiments, a solvent comprises methanol or acetonitrile. In some embodiments the electrode is redox-active, conductive, polycationic and coordinating. In these embodiments, the depositing is made in an inert gas environment. In various embodiments, the inert gas is argon, carbon dioxide, or nitrogen gas.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention described herein.

FIG. 1A-C. PCz characterization and structure. (a) CV of the isolated, washed PCz/CF electrode (MeCN, 0.1 M LiClO₄). (b) FTIR of PCz/CF and Ni₃Fe₁-PCz/CF. (c) The structure of doped polycarbazole illustrating the potential roles of the functional groups during the OER.

FIG. 2A-D. Performance of electrodes on PCz/CF. (a) OER LSV with different ratios of NiFe, CoFe, and control electrodes (CF, PCz/CF, and Co₃Fe₁, Ni₃Fe₁ without PCz) in 1 M KOH at 1 mV s⁻¹. (b) Tafel slope, (c) double layer capacitance, and (d) mass activity (left) and TOF (right) at 1.454 V vs. RHE curves for Ni₁Fe₁, Ni₃Fe₁, Ni₉Fe₁-PCz/CF.

FIG. 3A-D. Stability of Ni₃Fe₁-PCz/GC and Ni₃Fe₁-Nafion/GC electrodes. (a) The galvanostatic OER over Ni₃Fe₁-PCz/GC and Ni₃Fe₁-Nafion/GC for 24 h at 10 mA cm⁻². (b) LSVs over Ni₃Fe₁-PCz/GC and Ni₃Fe₁-Nafion/GC before and after 24 h stability tests. (c) Nyquist plots (at 0.5 V vs. SCE) for Ni₃Fe₁-PCz/GC and Ni₃Fe₁-Nafion/GC before and after the 24 h stability tests. (d) Tafel slope of Ni₃Fe₁-PCz/GC and Ni₃Fe₁-Nafion/GC before stability tests.

FIG. 4. Morphology of Ni₃Fe₁-PCz/CF electrode. (a) SEM surface morphology of the Ni₃Fe₁-PCz/CF and EDX elemental mapping of (b) Ni, (c) Fe, (d) Cl, and (e) 0.

FIG. 5. Morphology of Ni₃Fe₁-PCz/Ni_{foam} electrode. (a) SEM surface morphology of the Ni₃Fe₁-PCz/Ni_{foam} and EDX elemental mapping of (b) Ni, (c) Fe, (d) C, and (e) N.

FIG. 6A-D. OER performance of Ni₃Fe₁-PCz/Ni_{foam} electrode. (a) LSV curves of Ni_{foam}, PCz/Ni_{foam}, Ni₃Fe₁/Ni_{foam}, Ni₃Fe₁-Nafion/Ni_{foam} and Ni₃Fe₁-PCz/Ni_{foam} in 1 M KOH at 1 mV s⁻¹. (b) Galvanostatic tests of Ni₃Fe₁-Nafion/Ni_{foam} and Ni₃Fe₁-PCz/Ni_{foam} at 100 mA cm⁻² over 24 h. (c) Galvanostatic tests of Ni₃Fe₁-PCz/Ni_{foam} at 100 mA cm⁻² over 120 h in 6 M KOH and at 85° C. versus Hg/HgO, or (d) RHE, without and with iR correction.

FIG. 7. Growth of polycarbazole on carbon fiber paper (CF). (a) 45 cycles CV of CF electrode (area ~1 cm×1 cm) in MeCN (0.1 M LiClO₄ and 0.005 M carbazole). (b) Corresponding of determining E1/2 FC/FC⁺ reference in the same solution. The oxidation peak is at 0.423 V, and the reduction peak is at 0.0674 V vs. Ag/Ag⁺, E1/2=0.245 V.

FIG. 8. Picture of the CF electrodes. Polycarbazole grown on carbon fiber paper (PCz/CF), NiFe-PCz/CF, CoFe-PCz/CF, and the NiFe-PCz/CF(A), CoFe-PCz/CF(A) after 20 h stability test. The color changes from green (PCz/CF) to yellow (NiFe-PCz/CF) and green-yellow (CoFe-PCz/CF) after coordinating metal ions on the surface. NiFe-PCz/CF and CoFe-PCz/CF turn brown after 20 h stability test at 10 mA cm⁻².

FIG. 9. Estimation of polymer amount on PCz/CF electrode. (b) I-t curve and (a) corresponding LSV curve; Scan rate 100 mV s⁻¹.

FIG. 10. Estimation of Ni amount on Ni₃Fe₁-PCz/CF electrode. (b) I-t curve and (a) corresponding LSV curve (A); Scan rate 1 mV s⁻¹.

FIG. 11. Comparison of literature with relatively low catalyst mass loading vs. OER overpotential. The mass loading of Ni₃Fe₁-PCz/Ni_{foam} is estimated from the Fe amount in ICP-OES supposing the ratio of Ni to Fe is 3:1. The comparison is according to these refences.

FIG. 12A-D. Determine Double layer capacitance (C_{dl}) of NiₓFe_{y}-PCz/CF electrodes. (a) CV scanning of Ni₁Fe₁-PCz/CF, (b) Ni₃Fe₁-PCz/CF, and (c) Ni₉Fe₁-PCz/CF for ECSA estimation. (d) The corresponding C_{dl} numbers are shown in the graph.

FIG. 13A-D. Determine Double layer capacitance (C_{dl}) of CoₓFe_{y}-PCz/CF electrodes. (a) CV scanning of Co₁Fe₁-PCz/CF, (b) Co₃Fe₁-PCz/CF, and (c) Co₉Fe₁-PCz/CF for ECSA estimation. (d) The corresponding C_{dl} numbers are shown in the graph.

FIG. 14A-D. Stability of Ni₃Fe₁-PCz/GC and 5Ni₃Fe₁-Nafion/GC electrodes. (a) The galvanostatic OER over Ni₃Fe₁-PCz/GC and 5Ni₃Fe₁-Nafion/GC for 24 h at 10 mA cm⁻². (b) LSVs over Ni₃Fe₁-PCz/GC and 5Ni₃Fe₁-Nafion/GC before and after 24 h stability tests. (c) Nyquist plots (at 0.5 V vs. SCE) for Ni₃Fe₁-PCz/GC and 5Ni₃Fe₁-Nafion/GC before and after the 24 h stability tests. (d) Tafel slope of Ni₃Fe₁-PCz/GC and 5Ni₃Fe₁-Nafion/GC before stability tests.

FIG. 15A-D. Performance of Ni₃Fe₁-PCz/CF and Ni₃Fe₁-Nafion/CF electrodes. (a) The galvanostatic OER over Ni₃Fe₁-PCz/CF and Ni₃Fe₁-Nafion/CF for 20 h at 10 mA cm⁻². (b) LSVs over Ni₃Fe₁-PCz/CF and Ni₃Fe₁-Nafion/CF before and after 20 h stability tests. (c) Nyquist plots (at 0.5 V vs. SCE) for Ni₃Fe₁-PCz/CF and Ni₃Fe₁-Nafion/CF before and after the 20 h stability tests. (d) Tafel slope of Ni₃Fe₁-PCz/CF and Ni₃Fe₁-Nafion/CF before stability tests.

FIG. 16A-D. XPS of the electrodes on CF. (a) The Ni 2p and (b) Fe 2p regions in the high-resolution XPS spectra of Ni₃Fe₁-PCz/CF before, and after the long-term galvanostatic OER (Condition: Time, 20 h; Current, 10 mA/cm⁻²; Solution, 1 M KOH). (c) and (d) are the Co 2p and Fe 2p regions in the high-resolution XPS spectra of Co₃Fe₁-PCz/CF.

FIG. 17. Picture of glass electrodes. Picture of polycarbazole grown on ITO glass (PCz/ITO); after soaking PCz/ITO in methanol for 24 h and dry (PCz (methanol)/ITO glass); after soaking PCz/ITO in methanol with Ni²⁺ ions for 24 h (Ni-PCz (methanol)/ITO glass) and after soaking PCz/ITO in methanol with Fe²⁺ ions for 24 h (Fe-PCz (methanol)/ITO glass) and dry.

FIG. 18. UV-Vis of different polycarbazole electrodes on ITO glass. (a) The UV-Vis graph subtracts undoped PCz/ITO glass as blank: Polycarbazole on ITO glass without soaking in methanol (doped PCz/ITO glass); Polycarbazole on ITO glass after soaking with Ni ions (undoped Ni-PCz/ITO glass); Polycarbazole on ITO glass after soaking with Fe ions (undoped Fe-PCz/ITO glass) and Polycarbazole on ITO glass after soaking in methanol without metal ions (undoped PCz/ITO glass). (b) The original UV-Vis graph without subtraction. The peak around 700 nm in undoped Ni-PCz/ITO glass represents the presence of Ni ions. The peak around 400 nm in both undoped Ni or Fe-PCz/ITO glass represents the presence of Ni and Fe ions. However, the Fe-PCz/ITO glass peak starts earlier and is stronger.

FIG. 19. Comparison of CVs with or without carbazole on Ni foam. (a) 45 cycles CV of electropolymerization carbazole on Ni foam with 0.0050 M carbazoles and (b) without carbazole in 0.10 M LiClO₄ MeCN solution.

FIG. 20. Comparison of Ni_{foam} and PCz/Ni_{foam} electrodes. (a) 10 cycles CV of Ni_{foam} and (b) PCz/Ni_{foam} electrode (area ~1 cm×1 cm) in DCM with 0.1 M TBAPF6). (c) Corresponding of determining E1/2 of FC/FC⁺ reference in the same solution. The oxidation peak is at 0.555 V, and the reduction peak is at −0.149 V vs. Ag/Ag⁺. Therefore, E1/2=0.203 V.

FIG. 21. Picture of Ni foam (Ni_{foam}) electrodes. Picture of Ni_{foam}, polycarbazole grew on Ni_{foam} (PCz/Ni_{foam}), and NiFe metal ions coordinate on the polycarbazole (Ni₃Fe₁-PCz/Ni_{foam}).

FIG. 22. Morphology of Ni_{foam} electrodes. SEM surface morphology of the (a) Ni_{foam}, (b) PCz/Ni_{foam}, and (c) Ni₃Fe₁-PCz/Ni_{foam}.

FIG. 23. Comparison FTIR of Ni_{foam} electrodes. (a) FTIR spectra of the PCz/Ni_{foam} and (b) Ni₃Fe₁-PCz/Ni_{foam} electrodes.

FIG. 24A-F. Comparison XPS of Ni_{foam} electrodes. XPS of (a) C 1s, (b) N 1s, and (c) O 1s in PCz/Ni_{foam}; XPS of (d) C 1s, (e) N 1s, and (f) O 1s in Ni₃Fe₁-PCz/Ni_{foam}.

FIG. 25. Ni, Fe XPS in Ni₃Fe₁-PCz/Ni_{foam}. (a) The Ni 2p and (b) Fe 2p regions in the high-resolution XPS spectra of Ni₃Fe₁-PCz/Ni_{foam}.

FIG. 26. Estimation of Ni amount on Ni₃Fe₁-PCz/Ni_{foam} electrode. (b) I-t curve and (a) corresponding LSV curve; Scan rate 1 mV s⁻¹.

FIG. 27. Galvanostatic stability test of Ni₃Fe₁-PCz/Ni_{foam} at 10 mA cm⁻² over 22 h. The performance of Ni₃Fe₁-PCz/Ni_{foam} at 10 mA cm⁻² was read after the stability test.

FIG. 28. Tafel slope of Ni₃Fe₁-PCz/Ni_{foam} electrode. Conditions: in 1 M KOH and scan rate of 1 mV s⁻¹.

FIG. 29. Stability test of Ni₃Fe₁-PCz/Ni_{foam}. (a) The LSV curves of Ni₃Fe₁-PCz/Ni_{foam} electrode before and after 24 h stability test 1 M KOH, scan rate 5 mV/s. (b) Nyquist plots of the Ni₃Fe₁-PCz/Ni_{foam} electrode before and after the 24 h stability test at 0.5 V vs. SCE. The curves are not in perfect shapes and may originate from O₂ bubble interference at this relatively high voltage.

FIG. 30. Stability test of Ni₃Fe₁-PCz/Ni_{foam} electrode under harsh conditions. Nyquist plot of the Ni₃Fe₁-PCz/Ni_{foam} electrode after 120 h stability test in 6 M KOH and 85° C. at 0.5 V vs. Hg/HgO reference electrode.

FIG. 31A-F. XPS of CF substrate electrodes. XPS of (a) C 1s, (b) N 1s, and (c) O 1s in Ni₃Fe₁-PCz/CF; XPS of (d) C 1s, (e) N 1s, and (f) O 1s in Co₃Fe₁-PCz/CF.

FIG. 32. Illustration of atoms observed by XPS. (a) sp2 C bonded to —C and —N, (b) N⁺ in doped polycarbazole, (c) N coordinated to the metal.

FIG. 33. XPS survey spectra. From top to bottom: Co₃Fe₁-PCz/CF; Ni₃Fe₁-PCz/CF; Ni₃Fe₁-PCz/Ni_{foam}; PCz/Ni_{foam}.

FIG. 34. Chemical stability test of PCz. (a, b) PCz/CF in 6 M KOH and 1 M KOH over 240 h. (c, d) PCz/Ni_{foam} in 1 M KOH and 6 M KOH over 240 h. (e, f) 1 M KOH and 6 M KOH without any electrode.

FIG. 35. Electrodes before and after CV tests. (a, b) after soaking the PCz/CF electrodes in 6 M KOH or 1 M KOH for 240 h, then washing with triple-distilled water before CV tests. (c, d) after soaking the PCz/CF electrodes in 6 M KOH or 1 M KOH for 240 h, then washing with triple-distilled water before CV tests. (e-h) a, b, c, and d electrodes after CV tests.

FIG. 36A-D. CVs before and after soaking in KOH. (a, b) CVs of PCz/CF electrodes before and after 1 M KOH soaking over 240 h. (c, d) CVs of PCz/CF electrodes before and after 6 M KOH soaking over 240 h.

FIG. 37. Performance of electrodes on PCz/CF substrates. (a) Tafel slope, (b) double layer capacitance, and (c) mass activity (left) and TOF (right) at 1.50 V vs. RHE curves for Co₁F₁, Co₃F₁, and Co₉F₁-PCz/CF.

FIG. 38. Galvanostatic tests of Ni3Fe1-PCz/CF at 10 mAcm⁻² over 24 h of simulated seawater (0.5 M NaCl) in 6 M KOH and at 85° C. versus RHE.

FIG. 39. Galvanostatic tests of Ni3Fe1-PCz/Ni_{foam} at 100 mAcm⁻² over 24 h of simulated seawater (0.5 M NaCl) in 6 M KOH and at 85° C. versus RHE.

### DETAILED DESCRIPTION

Disclosed herein are electrolysis electrodes and methods of making them that are more stable and more efficient than those currently used. The method requires electrodes that convert water into protons, electrons, and oxygen. A multifunctional polymer that conducts electrons, ions, and may co-react with the metal ions in oxygen evolution reaction (OER) is described. The electrodes were prepared in two steps from off-the-shelf reagents. They operate with low loadings of abundant catalysts and are among the most active (100 mA cm⁻² at 1.43 V vs. RHE (1.41 V, iR corrected)), and stable reported to date under harsh conditions (85° C., 6 M KOH, 120 hours (0.69% loss over the first 14.5 h, then 0.61% loss over 105.5 h)). Control experiments on glassy carbon electrodes showed that the disclosed polycarbazole system significantly outperformed a Nafion system of the same catalyst loading. This simple strategy can be applied to other types of electrodes.

Solar and wind energy are diffuse and intermittent. Efficient, high-capacity, and output storage methods are needed to transition to carbon-zero energy production. Electrochemical water splitting to form hydrogen and oxygen is a promising approach. Unfortunately, the electrooxidation of water to oxygen, called the oxygen evolution reaction (OER), is slow, and it remains a significant challenge to develop low-cost, stable OER electrodes with low overpotentials and loadings at high current densities. Further, electrode preparations must be straightforward and utilize abundant starting materials for widespread, large-scale utilization.

Non-precious metal OER electrocatalysts help fulfill these requirements. The reported systems are typically more active in the base. Cobalt and Nickel are common in OER electrocatalysts, and the performance of both is significantly improved when combined with even trace amounts of Fe. The mechanism by which Fe enhances the activity of Ni or Co towards the OER remains a topic of extensive investigation.

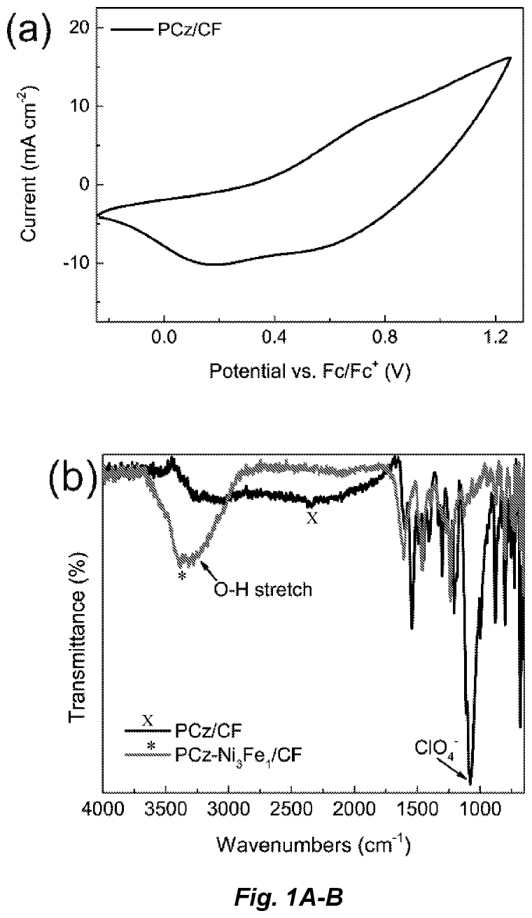

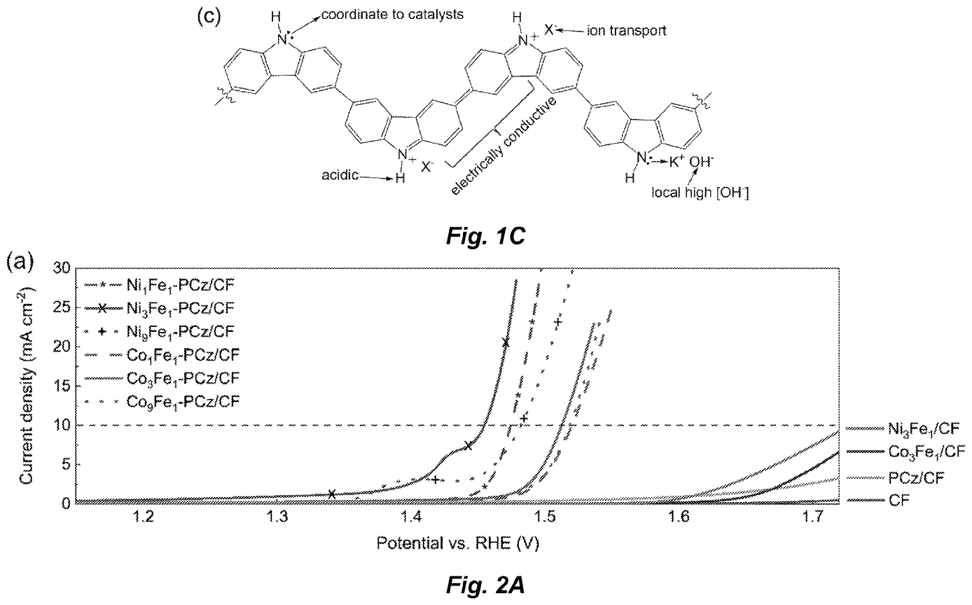

A significant consideration of OER electrocatalysts is their stability. Strategies to improve their stability include coating them with thin layers of polymers or metal oxides by atomic-layer deposition. A significant challenge with these approaches is controlling the thickness of the coating to minimize charge- and mass-transfer resistances. In principle, a polymer binder that conducts both electrons and ions, that allows mass transport to and from the active sites, that is stable, and that promotes the OER reactions at the active sites would optimize the utilization, activity, and stability of OER catalysts. Polycarbazole (PCz) and its derivatives are well-known (Polymers 2020, 12 (10), 2227). Doped (partially oxidized) PCz transports ions and water, which are requirements of ionomers in OER electrodes. Furthermore, PCz is a coordinating polymer, raising the possibility that coordination between N sites in the polymer and metal ions either in solution or on the surfaces of nanoparticles will direct the location, activity, and stability of OER catalysts. FIG. 1c illustrates the potential roles for PCz functional groups during the OER. Reported herein are the first polycarbazole-based OER electrodes. Active and stable OER electrodes were prepared in two simple procedures utilizing available materials.

Those skilled in the art will recognize that derivatives of carbazole may be utilized in place of carbazole. Non-limiting examples include derivatives represented by the following structure:

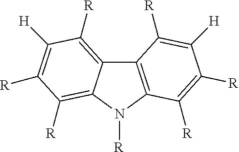

wherein each R is independently H, deuterium, alkyl, aryl (optionally substituted), acetylene, olefin (e.g., a C1-C10 alkene), ketone (e.g., an alkyl substituted by an oxo group), aldehyde (e.g., an alkyl substituted by an oxo group on its terminal carbon), ester (e.g., an oxycarbonyl wherein the carbonyl is substituted by an alkyl group), carboxylate (e.g., a carboxy substituent substituted by an alkyl group), an amide substituted by alkyl, —OH, —SO₃H, —SO₃R, —NR, or nitrile, wherein R is alkyl or aryl; and each alkyl, alkene, or aryl is optionally substituted.

Those skilled in the art will recognize that copolymers of carbazole and other monomers utilized in electropolymerization may also in used in place of polycarbazole to achieve a similar result and function. Such other monomers include, but are not limited to, aniline, pyrrole, or thiophene.

The substrate for polymerization of carbazole can be applied to any conductive surface, including various forms of Ni, Fe, Co, and Mn metals, C, or various alloys thereof. Polycarbazole can also attach to various types of semiconductors, which involves fluorine-doped tin oxide (glass), indium tin oxide (glass), TiO₂, Fe₂O₃, WO₃, or BiVO₄. Elements that can coordinate with polycarbazole for electrochemical water oxidation as catalysts include Ni (Ni(OH₂), NiOOH), Fe (Fe(OH₃), FeOOH), Co (Co(OH₂), CoOOH), Mn, Cr, Cu, Ru, Ir, or a combination of different metal (oxy)(hydro)oxides or ions, such as NiFe(Oₓ(H)), ZnCo(Oₓ(Hy)), SrCo(Oₓ(Hy)), ZnCo((O)Oₓ(H_{y})), LiFe((O)Oₓ(H_{y})), NiFeMn((O)Oₓ(H_{y})), NiFeCr((O)Oₓ(H_{y})), NiCr((O)Oₓ(H_{y})), NiFeRu((O)Oₓ(H_{y})), NiFeIr((O)Oₓ(H_{y})), CoFe((O)Oₓ(H_{y})), CoAl((O)Oₓ(H_{y})), and CoFeAl((O)Oₓ(H_{y})), wherein x and y are each independent integers of known values for each metal compound, such as 1, 2, 3, 4, 5, or 6, and the like, as appropriate for each compound.

These PCz electrodes have applications in water electrolyzers, metal-air batteries, fuel cells, and Li-ion batteries.

Table 1 describes catalysts that may be deposited on PCz electrodes. Such catalysts may be deposited from various solvents, including but not limited to, methanol, acetonitrile, ethanol, acetone, ethyl acetate, propanol, 2-propanol, n-butanol, tert-butanol, benzonitrile, nitromethane, dichloromethane, chloroform, tetrahydrofuran, propylene glycol, ethylene glycol, water, 2-methyltetrahydrofuran, or a combination thereof.

TABLE 1
Additional examples of catalysts that may be loaded onto the PCz electrode.

| Oxygen Reduction | Cathode of Lithium | | Oxygen Evolution |
|---|---|---|---|
| Reaction | metal batteries | Oxygen Sensors | Reaction |
| Pt | Commercial porous | palladium (II) meso-tetrakis | LiCoO₂ |
| | carbons, | (4-carboxyphenyl) porphyrin | |
| | particularly Ketjen Black | (PdTCPP) | |
| | (KB), BP2000, and super P. | | |
| Pd | electrolytic manganese | palladium (II) complex | LaFeO₃ |
| | dioxide | (PdTFPP) embedded in n- | |
| | | propyl trimos/teos/octyl-trieos | |
| | | composite xerogel | |
| Ru | Pt, Au, Pd | tris (4,7-diphenyl-1,10- | ZnCo₂O₄ |
| | | phenathroline) ruthenium (II) | |
| | | dichloride ([Ru(dpp)3]Cl₂) | |
| Ag | Pt/Au alloy, PdCu alloy | A polymer layer coated with a | SrCoO₃ |
| | | platinum | |
| | | tetrakis(pentafluorophenyl) | |
| | | porphyrin (PtTFPP) | |
| Co₃O₄ | MnO₂ | silicate film doped with bis(1- | Zn²⁺ into CoOOH |
| | | phenyl- | |
| | | isoquinoline)(acetylacetonato) | |
| | | iridium(III) [Ir(piq)2(acac)] | |
| SrCoO_{3-δ} | Al₂O₃ coating layers and | Gd-HMME | high-valence TM |
| | atomically deposited Pd | (sensitive) | modulators X (X: W, |
| | nanoparticles on the | filter paper | Mo, Nb, Ta, Re, |
| | carbon surface | (reference) | and MoW) |
| | | | incorporated into |
| | | | multi-transition metal |
| | | | (e.g., Fe, Co, and Ni) |
| | | | oxyhydroxides |
| La_{0.5}Sr_{0.5}Co3 − δ | In₂O₃ atomic | I2-BODIPY | e SrFeO_{3-σ} (SFO), |
| | overlayers further | | BaₓSr₁₋ₓCo_{y}Fe_{1-y}O₃ |
| | functionalized by RuOx | | (BSCF), and |
| | nanoparticles | | PrₓBa₁₋ₓCoO_{3-σ} |
| | | | (PBCO) |
| LaCoO₃ | CuCo₂O₄, NiCo₂O₄, | Ru(bpy)₃Cl₂ | CoAl₂O₄, |
| | MnCo₂O₄ | | CoFe_{0.25}Al_{1.75}O₄ |
| Co—M (M is Mn, | TiO₂, Ti₄O₇ | | Ru, Ir |
| Fe, Ni, Cu, Zn, Mo) | | | |
| AB₂O₄ spinels (A: | TiN | | |
| Mn, Fe, Co, Ni, and | | | |
| Cu; and B: Mn, Fe, | | | |
| and Co) | | | |
| MnO₂ | TiC | | |
| Pb₂Ru₂O₇ | CaMnO₃, LaNiO₃, and | | |
| | LaFeO₃ | | |
| MnCo₂O₃ | | | |
| TiN, VN, CrN, | polyaniline | | |
| Mn nitrides, Fe | (PANI), polypyrroles (PPy), | | |
| nitrides, Co nitrides, | and poly(3,4-ethylene | | |
| Ni nitrides, Cu₃N, | dioxythiophene) (PEDOT) | | |
| MoN | | | |
| Co₂N/C, Co₃N/C | tubular PPy (TPPy) | | |
| and Co₄N/C | | | |
| MN (M = Ti, V, Cr, | Various MOFs, such as | | |
| and Mn) and M₃N | MOF-5, HKUST-1, and M- | | |
| (M = Fe, Co, and | MOF-74 (M = Co, Mg, and | | |
| Ni) | Mn), were investigated as | | |
| | air-electrodes. | | |
| Fe, Co, Mn, Ni, Cu | | | |

### EXAMPLES

Various exemplary embodiments of devices and compounds as generally described above and methods according to this invention, will be understood more readily by reference to the following examples, which are provided by way of illustration and are not intended to be limiting of the invention in any fashion.

### Example 1. Materials and Instrumentation

The following materials and instrumentation were used throughout the experiments described below in Examples 2-19. Potassium Hydroxide (KOH, Aldrich, semiconductor grade, 99.99%); Nickel(II) Chloride Hexahydrate (NiCl₂·6H2O, Baker, 98%); Iron(II) Chloride Tetrahydrate (FeCl₂·4H₂O, Aldrich, 99%); Cobalt(II) Chloride Hexahydrate (CoCl₂·6H₂O, ACP, 98%); Carbazole (C₁₂H₉N, Sigma, 95%); Lithium Perchlorate (LiClO₄; GFS); Acetonitrile (C₂H3N, Sigma-Aldrich, 99.9%); Methanol (CH₄O, Sigma-Aldrich, 99.8%), Ni foam (Ni, GoodFellow, 99.5%, porosity 95%, thickness 1.6 mm), Hydrochloric Acid (HCl, Fisher, 36.5%-38%, ACS grade), Toray carbon fiber paper (C, Fuel Cell Earth, P50), glassy carbon electrodes (5 mm diameter), and Nafion solution (Fuel Cell Earth, D1021, 10% wt.). All experiments use triple-distilled water.

Electrochemical studies were carried out using a Solartron SI 1287 Electrochemical Interface. X-ray photoelectron spectroscopy (XPS) measurements were done using a Kratos AXIS Ultra. A monochromatized Al Kα source (hν=1486.6 eV) was used at 12 mA and 14 kV, while the pressure in the sample analytical chamber was maintained at <1×10⁻⁹ torr. Survey scans ran at 1100 to 0 eV binding energy, with an analyzer pass energy of 160 eV and 0.3 eV steps. All spectra are calibrated by the C is line at 284.8 eV for deconvolution. ICP-OES data are collected by Thermo iCAP6300 Duo (N. America). Thermo iCAP6300 Duo (N. America) inductively coupled plasma-optical emission spectrometer (ICP-OES) was used to characterize the concentration and amount of metal ions.

Typically, the samples are weighed in concentrated trace metal grade HNO₃, then left overnight. Before analysis, the final volume of the solution was 5 mL and then digested using a modified EPA 3051a. In reflection mode, UV-vis spectra were collected using the Cary 5000 UV-vis spectrometer by ITO glasses as substrates. FTIR was measured by Thermo Nicolet 8700 FTIR Spectrometer and Continuum FTIR Microscope on ATR. SEM images and EDX elemental mapping images were collected by Zeiss Sigma (Gemie) Field Emission Scanning Electron Microscope (FE-SEM) with EDX/EBSD; the system vacuum of FE-SEM is lower than 2×10⁻⁵ torr when acquiring images.

### Example 2. Substrate Preparation

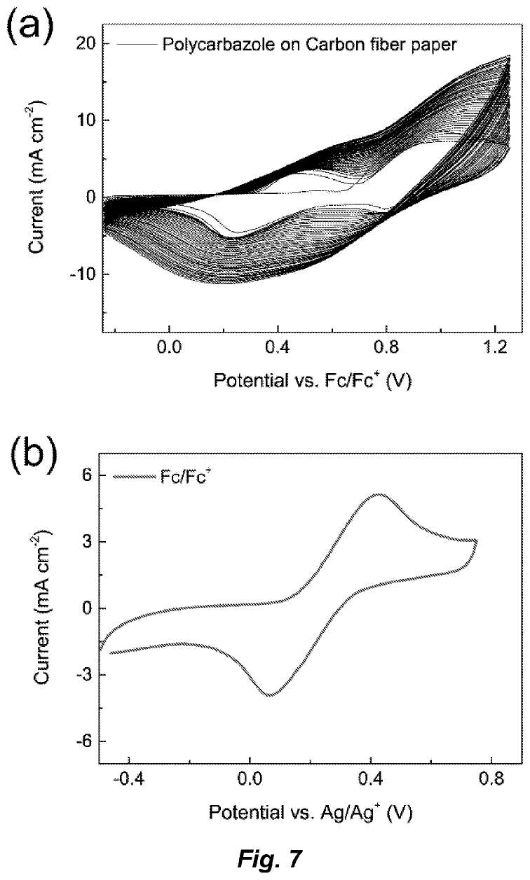

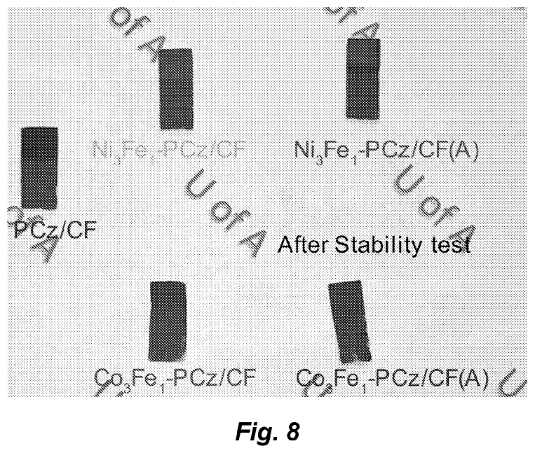

The electrode preparation begins with the electropolymerization of carbazole over carbon fiber paper (CF) in MeCN (0.1 M LiClO₄) with cyclic voltammetry (CV, −0.245 to 1.255 V vs. Fc/Fc⁺ (Fc=ferrocene), 100 mV s⁻¹, 45 cycles). FIG. 7 shows the voltammograms recorded during the polymerization. FIG. 1a shows the CV of the washed, isolated green (FIG. 8) doped polycarbazole/carbon fiber paper electrode (PCz/CF) in MeCN (0.1 M LiClO⁴). There are only small differences between the final CV cycles during the polymerization and those of the isolated polymer. In the anodic sweep, the lower peak at ~0.55 V is attributed to one-electron oxidation (doping) to form a delocalized cationic radical. The higher peak (~0.94 V) is proposed to arise from further oxidation to a dicationic species. Doped-PCz is green and electronically conductive due to the presence of the conjugated polycations. Assuming the area under the first peak in the positive-going sweeps arises from one-electron oxidation, the amount of electrochemically accessible carbazole groups is estimated to be ~1×10⁻⁶ mol cm⁻². FIG. 1b shows the Fourier-transform infrared spectrum (FTIR) of the PCz/CF. The spectrum is like those reported for doped polycarbazole. The strong peak at ~1100 cm⁻¹ arises from the perchlorate counterion. The peak at ~1550 cm⁻¹ has been assigned to doped-PCz, and the peak at ~856 cm⁻¹ is assigned to the substitution pattern of polymer. Detailed discussions of FTIR are provided in the Examples, below. FIG. 1c illustrates the structural features of doped-PCz and selected roles it may play as a multifunctional binder in OER electrodes.

### Example 3. Coordinative Deposition and OER Performance Over PCz/CF

The second step in the electrode preparation is the electrocatalyst deposition from NiCl₂·6H₂O, FeCl₂·4H₂O, or CoCl₂·6H₂O in methanol. Methanol was used as solvent in part to swell the polymer film. The deposition is carried out under Ar for the first 24 h to avoid oxidation of Fe(II). These coordinative depositions likely begin with the coordination of Ni, Co, or Fe ions to the nitrogen sites on PCz (FIG. 1c). For example, PCz sensors operate by different types of reactions at nitrogen. After 24 h, the electrodes were left in the air overnight to oxidize the Fe(II) to Fe(III), washed with MeOH to remove any excess precursors, and utilized for the OER without further treatment.

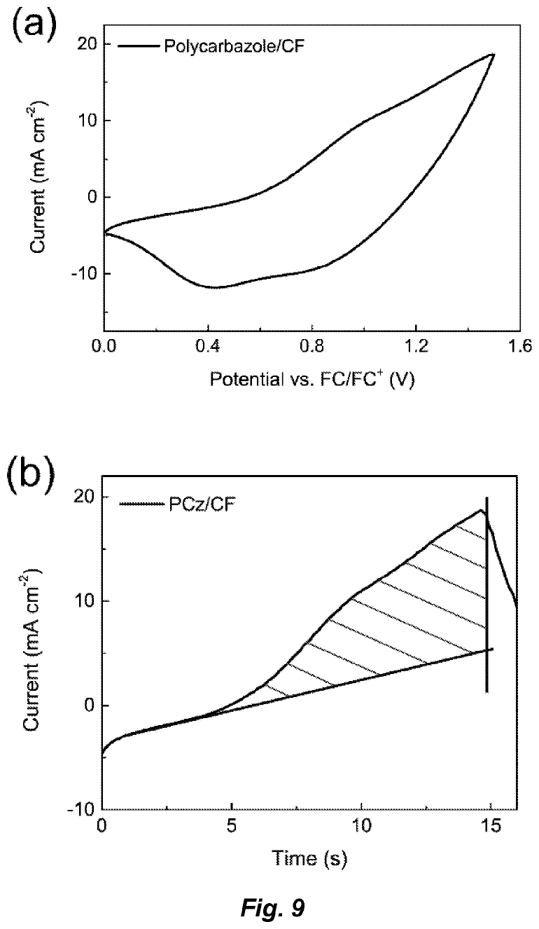

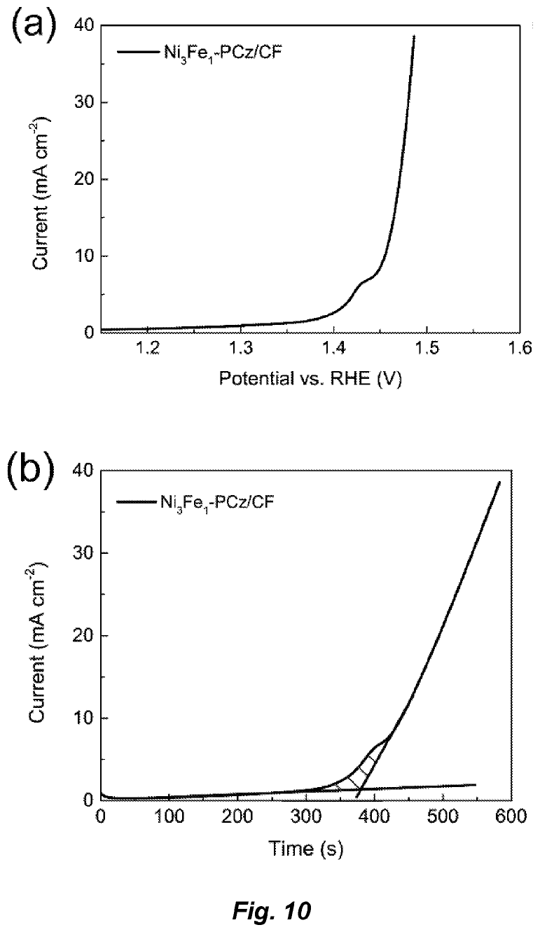

Table 2 summarizes the concentrations of Ni(II), Fe(II), and Co(II) employed during the depositions and the amounts in the resulting MₓFe_{y}-PCz/CF electrodes (M=Ni or Co), as determined by inductively-coupled plasma optical emission spectroscopy (ICP-OES). The total (Ni or Co+Fe) mole loadings in the OER electrodes ranged from 1.5 to 2.8×10⁻⁶ mol cm⁻². The amount of electrochemically accessible carbazole in the PCz/CF deposit (1×10⁻⁶ mol cm⁻², FIG. 9) resembles the amount of Ni+Fe (2.8×10⁻⁶ mol cm⁻²) in the Ni₃Fe₁-PCz/CF electrode. Further, the charge under the Ni(II) to Ni(III) oxidative wave in the linear sweep voltammogram of this electrode (FIG. 10) corresponds to 1.3×10⁻⁶ mol cm⁻² of Ni. The consistency among these rough estimates suggests that the deposition involves the coordination of Ni(II) and Fe(II) to the accessible nitrogen sites in PCz. The excess metal ions in the electrode (ICP-OES) suggest that catalyst growth proceeds further after coordination. Further studies are required to determine the exact mechanism of the coordinative deposition.

TABLE 2
Concentrations of Ni(II), Fe(II), and Co(II).

| | Co | Fe | The ratio of | Co (μ | Fe (μ | C_{dl} |
|---|---|---|---|---|---|---|
| Label | (μg) | (μg) | Co to Fe | Moles) | Moles) | (mF) |
| Co₁Fe₁ | 57.91 | 64.41 | 0.853:1 | 0.983 | 1.153 | 23.76 |
| Co₃Fe₁ | 86.45 | 32.12 | 2.55:1 | 1.467 | 0.575 | 42.87 |
| Co₉Fe₁ | 77.9 | 10.03 | 7.39:1 | 1.322 | 0.179 | 31.01 |

| | Ni | Fe | The ratio of | Ni (μ | Fe (μ | C_{dl} |
|---|---|---|---|---|---|---|
| Label | (μg) | (μg) | Ni to Fe | Moles) | Moles) | (mF) |
| Ni₁Fe₁ | 53.3 | 50.4 | 1.01:1 | 0.908 | 0.902 | 5.05 |
| Ni₃Fe₁ | 124.43 | 35.75 | 3.31:1 | 2.12 | 0.64 | 5.10 |
| Ni₉Fe₁ | 100.89 | 17.47 | 5.51:1 | 1.719 | 0.312 | 4.89 |

ICP-OES results of different ratios of Ni, Fe and Ni, Co electrodes. The mole ratios and Double layer capacitance (C_{dl}) numbers are calculated and shown in the table.

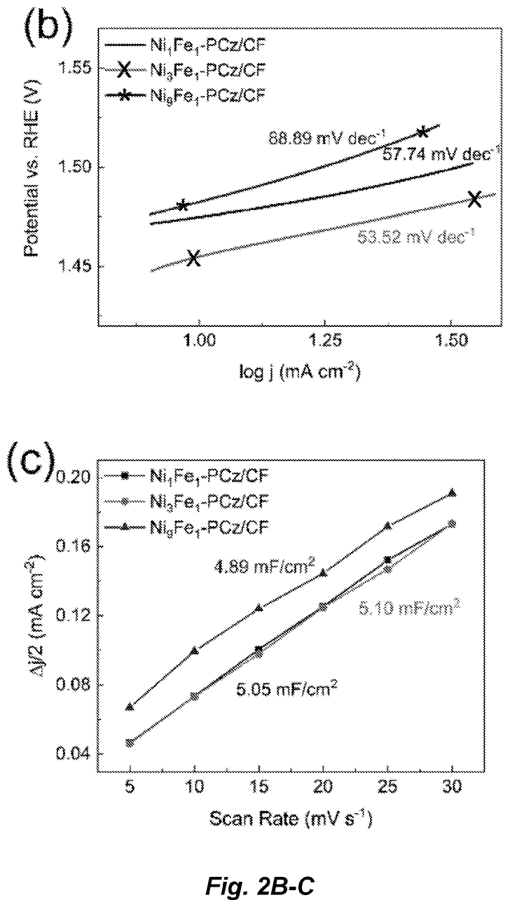

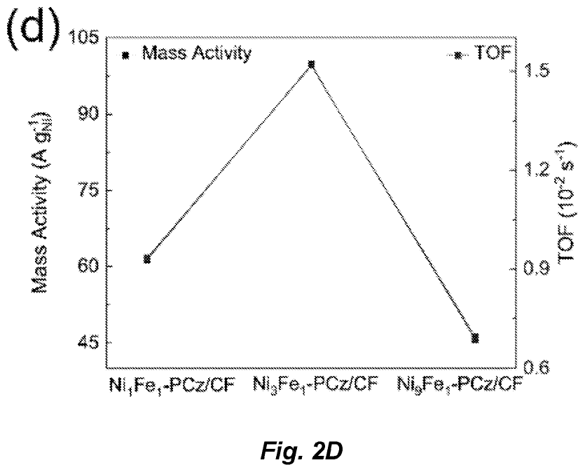

The OER activities were determined by linear sweep voltammetry (LSV) and galvanostatic experiments under alkaline conditions (FIG. 2a, 1 mV s⁻¹, 1 M KOH, room temperature). The NiₓFe_{y} electrodes were more active than CoₓFe_{y}. The NiₓFe_{y} LSVs contained the known Ni²⁺ to Ni³⁺ oxidative wave that shifts in the positive direction with increasing amounts of Fe (~1.38 V for Ni₉Fe₁, ~1.43 V for Ni₃Fe₁, obscured for Ni₁Fe₁). We extrapolated the linear portion of the OER curve to the potential axis to estimate the onset potentials of the NiₓFe_{y}-PCz/CF electrodes, giving 1.438 V, 1.452 V, and 1.461 V (vs. RHE) for Ni₃Fe₁-, Ni₉Fe₁-, and Ni₁Fe₁-PCz/CF, respectively, with Ni₃Fe₁ being the most active. The onset potential for Ni₃Fe₁-PCz/CF is similar to that we reported for Ni₃Fe₁ prepared by a different procedure (ACS Sustainable Chem. Eng. 2017, 5 (1), 1106). The onset potentials for CoₓFe_{y} were higher than NiₓFe_{y}.

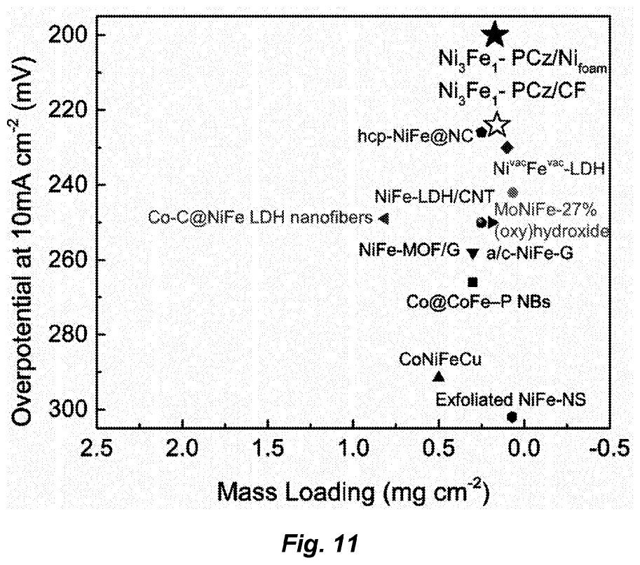

The LSV overpotentials at 10 mA cm⁻² increased in the order Ni₃Fe₁-PCz/CF (224 mV)<Ni₁Fe₁-PCz/CF (245 mV)<Ni₉Fe₁-PCz/CF (253 mV). The overpotential at 10 mA cm⁻² for the Ni₃Fe₁-PCz/CF electrode is among the lowest reported in the literature, despite the relatively low loading of Ni+Fe in this electrode (FIG. 11). The overpotentials for the Co—Fe electrodes increased in the order were Co₃Fe₁-PCz/CF (283 mV)<Co₉Fe₁-PCz/CF (289 mV)~Co1Fe1-PCz/CF (291 mV). The control electrodes PCz/CF, Ni₃Fe₁—CF, and Co₃Fe₁—CF were essentially inactive. The Ni₃Fe₁-PCz/CF electrode was superior to the others in this study.

### Example 4. Preparation of Polycarbazole (PCz) on Carbon Fiber Paper (CF) (PCz/CF) or Glassy Carbon (GC)

The CF was cut into 1 cm×2.5 cm, then sonicated in distilled water for 30 minutes. After drying in an oven at 60° C. for 30 min, the CF was ready to use for the next step. For GC electrodes, they were first polished with 5 μm, 0.3 μm, and 0.05 μm alumina, respectively. The GC electrodes were followed by being sonicated in water for a few seconds and washed with TD water, then dried with N₂ gas. Electropolymerization was carried out in distilled acetonitrile (MeCN) solution, with 5 mM of carbazole and 0.1 M of LiClO₄. CVs were acquired by sweeping 0-1.5 V vs. Ag wire (−0.245 to 1.255 V vs. Fc/Fc⁺, Fc=Ferrocene) at a scan rate of 100 mV s⁻¹ for 45 cycles, with Ag wire as the reference electrode and graphite rod as the counter electrode. Ferrocene was added after the experiment as an internal reference. After polymerization, the electrodes were washed with MeCN and dried in the oven at 60° C.

### Example 5. Preparation of Polycarbazole (PCz) on Ni Foam (PCz/Ni_{foam})

Ni foam was cut into 1 cm×3 cm small pieces and soaked into 1 M HCl for 10 min to remove surface oxides and other impurities with sonication. After 10 min, the Ni foam was removed from the bath and washed with triple distilled water and ethanol. After drying in an oven at 60° C. for 30 min, the Ni foam was used for electropolymerization. The electropolymerization was carried out in freshly distilled acetonitrile (MeCN) solution, with 5 mM of carbazole as raw material and 0.1 M of LiClO₄ as electrolyte. CVs were operated by sweeping between −0.245 to 1.755V vs. Fc/Fc⁺ at a scan rate of 100 mV s⁻¹ for 45 cycles, with Ag wire as the reference electrode and Pt mesh as the counter electrode. Ferrocene was added after the experiment to obtain a reference potential. After polymerization, the electrodes were washed with MeCN and dried in the oven at 60° C.

### Example 6. Loading NiFe or CoFe Metal Ions on PCz/CF or PCz/Ni_{foam} (NiₓFe_{y}-PCz/CF or NiₓFe_{y}-PCz/Ni_{foam})

The PCz/Ni_{foam} or PCz/CF electrodes were transferred into Schlenk tubes, switched between vacuum (3 min) and argon gas (1 min) for 3 times to remove air, and left under argon gas environment. In individual containers, methanol and the metal salts were purged with argon for 30 min and then mixed to give solutions with a total concentration of metals salts=0.2 M. The ratio of Ni to Fe is 3 to 1 for the most active electrodes. The different metal ion solutions were then transferred by syringe to Schlenk tubes containing the PCz/CF electrodes. The electrodes were exposed to the salt solution for 24 h under argon. The electrodes were then removed from the solution and dried in the air overnight to oxidize Fe²⁺ to Fe³⁺. They were then washed with methanol in air before further use.

### Example 7. Loading NiFe or CoFe Metal Ions on CF or Ni_{foam} (NiₓFe_{y}/CF or NiₓFe_{y}/Ni_{foam})

The NiₓFe_{y}/CF or NiₓFe_{y} NiₓFe_{y}/Ni_{foam} electrodes were prepared by the same procedures above, except for replacing PCz/CF or PCz/Ni_{foam} with CF or Ni_{foam}.

### Example 8. Loading Ni₃Fe₁ Metal Ions onto the Glassy Carbon Electrodes (GC), CF, or Ni_{foam} Control Electrodes Using Nafion as Binder

The Ni₃Fe₁ solutions (0.2 M) were prepared by dissolving the metal salts (NiCl2 and FeCl₂ (as hydrates)) in triple-distilled water (TD water) and ethanol with a ratio of 5 to 1 under argon. Next, for each 1 mL of Ni₃Fe₁ solution, 10 μL 10 wt. % of Nafion was added, followed by sonication for 30 min to make the catalyst ink. 15 μL of this solution was then drop-cast onto CF or Ni_{foam} to provide the same mass loading as the polycarbazole electrodes determined ICP-OES. The electrodes were then dried at 60° C. for ~30 min. The GC electrodes were first polished by in sequence by 5 μm, 0.3 μm, and 0.05 μm alumina, then briefly sonicated in water, washed with TD water, and dried under a stream of N₂. To obtain N₃Fe₁-Nafion/GC electrodes with 5× the mass loading of Ni₃Fe, 15 μL of the Ni₃Fe₁ (0.2 M) solution was drop-cast onto GC, then left in air overnight before use. To obtain 1 equivalent catalyst amount of N₃Fe₁-Nafion/GC electrodes, 0.02 M Ni₃Fe₁ solution was prepared. The preparation procedures of 0.02 M Ni₃Fe₁ solution were the same as for the 0.2 M Ni₃Fe₁ solution except for the total metal ion concentrations changed to 0.02 M. 30 μL of 0.02 M Ni₃Fe₁ solution was then drop cast onto GC.

### Example 9. Electrochemical Measurements

For room temperature electrochemical studies, 1 M KOH solution was pretreated with solid Ni(OH) to remove small traces of iron metals was prepared as described in the literature (ACS Sustainable Chem. Eng. 2017, 5 (1), 1106). A three-electrode system was used throughout the experiment, where the counter electrode was a graphite rod, and the reference electrode was a saturated calomel electrode (SCE). The reaction flask was a 100 ml three-neck round bottom flask. The linear sweep voltammetry (LSV) curves were measured at 1 mV s⁻¹. The current densities were iR corrected by the corresponding Electrochemical impedance spectroscopy (EIS). The reversible hydrogen electrode (RHE) voltage is calculated based on the equation: E (vs. RHE)=E (vs. SCE)+0.241 V+0.059×pH. The Tafel slope is calculated using the equation E=b log j, where E is the potential vs. RHE, b is the Tafel slope, and j is the current density. The following equation calculates the overpotential (I) for OER: η=E (vs. RHE)−1.23 V. EIS was acquired with a frequency range of 0.1-100 kHz at a bias potential of 0.5 V vs. SCE. To investigate the electrochemical active surface area (ECSA), the electrochemical double-layer capacitance (C_{dl}) was measured over a range of 0.15-0.25 V vs. SCE, which was the non-Faradaic region, at the rate ranging from 10 to 30 mV s⁻¹ at 5 mV increments. From the C_{dl}, the ECSA can be estimated using the equation ECSA=C_{dl}/Cs, where Cs is the specific capacitance of an atomically smooth material. Thus, ECSA is a linear relation to C_{dl} and can be used for comparison for a series of electrodes with a similar or same surface. For 6 M KOH at 85° C., a Hg/HgO reference electrode was used instead of SCE and converted into RHE as described below.

### Example 10. Conversion of Hg/HgO Voltage to RHE Voltage at 85° C. In 6 M KOH

The pH of 6 M KOH at 85° C. is estimated to be 13.59. The reversible hydrogen electrode (RHE) voltage is calculated based on the equation: E (vs. RHE)=E (vs. Hg/HgO)+0.098 V*+0.059×13.59.

Literature indicates that for the same concentration of NaOH (OH⁻), the increasing temperature may reduce the reference potential of Hg/HgO vs. NHE. Thus, the standard potential (Eo) may be lower than 0.098 V, possibly underestimating the performance of the electrodes. Furthermore, the filling solution in Hg/HgO reference electrode is 4.24 M KOH, which is lower than the outside environment of 6 M KOH. As time passes, water may leak from the inside reference electrode to the outside environment. Consequently, the concentration of KOH inside the reference electrode may rise, which may cause interference. However, more investigations are needed to solve the questions above.

### Example 11. iR Correction

We use the corresponding Nyquist plot to do iR correction. In brief, the intercept of the X axis is identified as the solution resistance (Rs) and multiplied by the current to obtain the shifted voltage (Vshift). The iR-corrected new voltage is the untreated voltage that subtracts the Vshift.

### Example 12. Estimation of Turnover Frequency (TOF)

Suppose Faraday efficiency is 100%, and Ni and Co are the active centers in the reaction. Therefore, The TOF can be estimated as below:

$$TOF = \frac{jA}{4 Fn}$$

Where j is the geometric current density at a given potential, A is the geometrical area, F is the Faraday constant, and n is the moles of Ni or Co on the electrodes.

### Example 13. Estimation of the Amount of Ni and Accessible PCz on the Electrodes Using Cyclic Voltammetry (CV)

Firstly, the I-t curves are plotted by the corresponding CV curves. Then, the total charge in Coulombs (Q) is calculated by integrating the corresponding peak in the I-t curve derived from the CV. Moreover, the moles of content on the electrodes (mole) can be calculated as follows:

$$mole = \frac{Q}{{N}_{A} e}$$

Where Q is the total charge of Coulomb calculated from FIGS. 9, 10, and 26, NA is the Avogadro constant, and e is the Coulomb number for one electron. The mass content was estimated by multiplication by the molar mass.

### Example 14. Identification of Growth Polycarbazole on Carbon Fiber Paper

The first sweep proceeds in the positive-going direction and contains one anodic peak at ~0.92 V vs. Fc/Fc⁺ (FIG. 7). This peak likely corresponds to the oxidation of dissolved carbazole to form the monocationic radical. This radical either bonds to the carbon surface or reacts with carbazole in solution to eventually form the 3,3′-dimer. The electropolymerization commences and propagates with this oxidation and proceeds as the voltage increases higher than ~0.92 V in the positive-going sweep. The subsequent cycles contain two anodic waves in the positive direction and two cathodic waves in the negative. With each subsequent sweep, these peaks grow, broaden, and shift to higher (anodic) or lower (cathodic) potentials.

This is typical behavior for the electropolymerization of carbazole. The lower peak (~0.75 V) in the anodic sweep likely arises from oxidation of the polycarbazole form to a monocationic radical. The higher peak (~0.92V) likely arises from further oxidation to a dicationic (~0.92 V) species, along with oxidation of carbazole in solution as part of polymer growth. The color of the electrode turns dark green as the polymerization proceeds, and the green color persists after washing with MeCN (FIG. 9). It is well known that polycarbazole turns green upon oxidation (doping) to form conjugated polycations. The shifting and broadening of these peaks during the polymerization arise, forming a thicker polymer layer. These effects include changes in electronic and ionic conductivity through the growing film.

### Example 15. Performance of the Ni₃Fe₁-PCz/CF and Ni₃Fe₁-Nafion/CF Electrodes

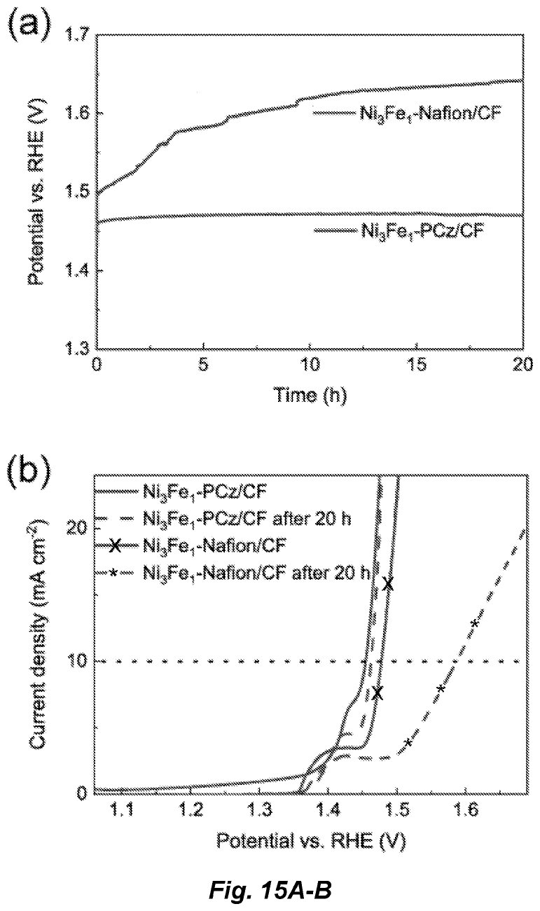

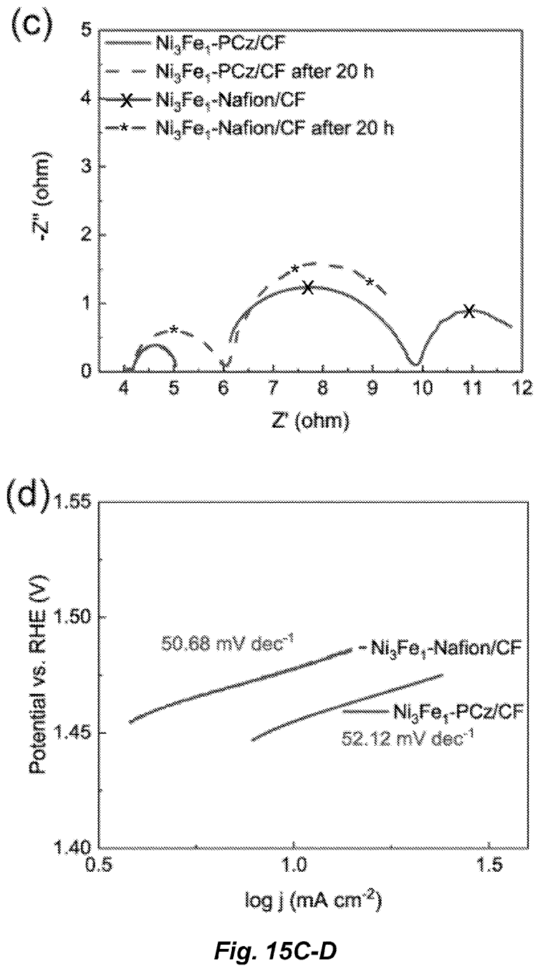

FIG. 15 compares Ni₃Fe₁ electrodes with the same mass loadings on CF prepared with polycarbazole and Nafion as binders. FIG. 15a shows the long-term galvanostatic OER at 10 mA cm⁻² with the Ni₃Fe₁-PCz/CF and Ni₃Fe₁-Nafion/CF electrodes (1.0 M KOH, room temperature). The potential of the PCz-based electrode rose slightly over 5 h and then stabilized at ~1.46 V (vs. RHE) over the remainder of the 20 h, demonstrating the stability of this system towards the OER. The slight increase in potential over the first 5 h may have resulted from a minor reconstruction of the electrode.

In contrast, the Nafion-based electrodes operated at higher, much less stable potentials throughout the experiment. FIG. 15b shows the LSV curves before and after the 20 h OER. The before and after LSVs of the PCz electrode are quite comparable, with the curve actually being more defined after the 20 h reaction. There are positive currents at low potentials in the LSV of the Ni₃Fe₁-PCz/CF electrode before the long-term reaction. These currents likely arose from the electrooxidation (doping) of the polycarbazole support. There was almost no decrease in the LSV current densities after the 20 h reaction.

The corresponding LSVs of the Nafion electrode showed significant degradation of activity. FIG. 15c shows the Nyquist plots (at 0.5 V vs. SCE) for the PCz- and Nafion-based electrodes before and after the 20 h reaction. The high-frequency resistance of the PCz-based electrode is low, indicating the polycarbazole is electronically conductive at this potential. There are very few resistances at low frequencies, and there is little change in the plot after the 20 h OER. We note that the charge transfer resistance (Rct) decreased slightly after 20 h. In contrast, the high-frequency resistance of the Nafion-based electrode is much higher, there are significant low-frequency resistances, and the Nyquist plot changes significantly after 20 h. While detailed investigations are required to determine the exact mechanisms responsible for the plots, it is clear that the PCz-binder significantly enhances and stabilizes the OER reaction.

### Example 16. Identification of Growth Polycarbazole on Ni Foam

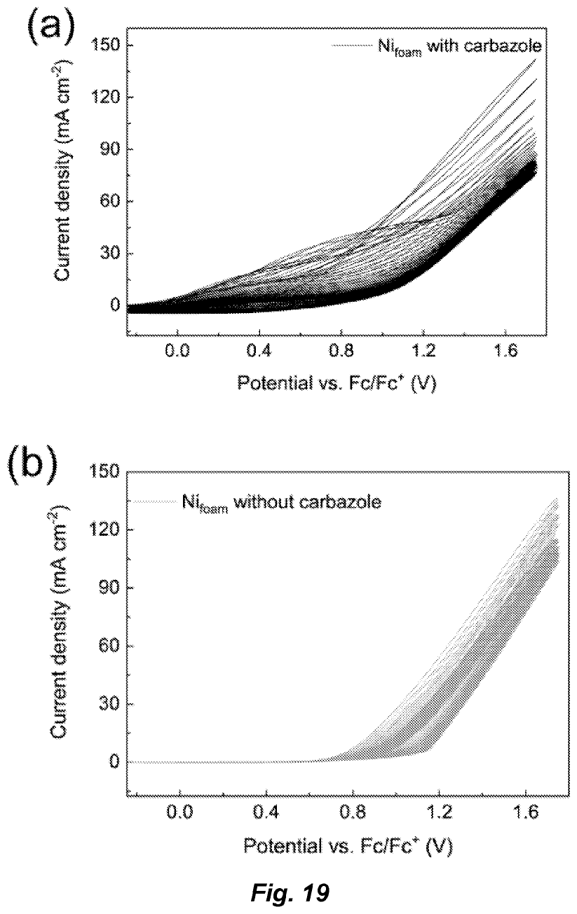

FIG. 19 shows the CVs of Ni foam in MeCN (0.1 M LiClO₄) both in the absence of carbazole and during the electropolymerization (0.005 M carbazole). The CV of the Ni foam in the absence of carbazole contains large, linear oxidative waves starting at 0.6 V in the forward and reverse directions caused by Ni oxidation, presumably forming [Ni(MeCN)₄]2+. Similar waves are present in the first sweeps of the CVs recorded during the carbazole electropolymerization. These waves decreased as the surface was covered by polycarbazole, leaving only waves for the polymerization of carbazole in the final sweeps.

### Example 17. XPS Identification

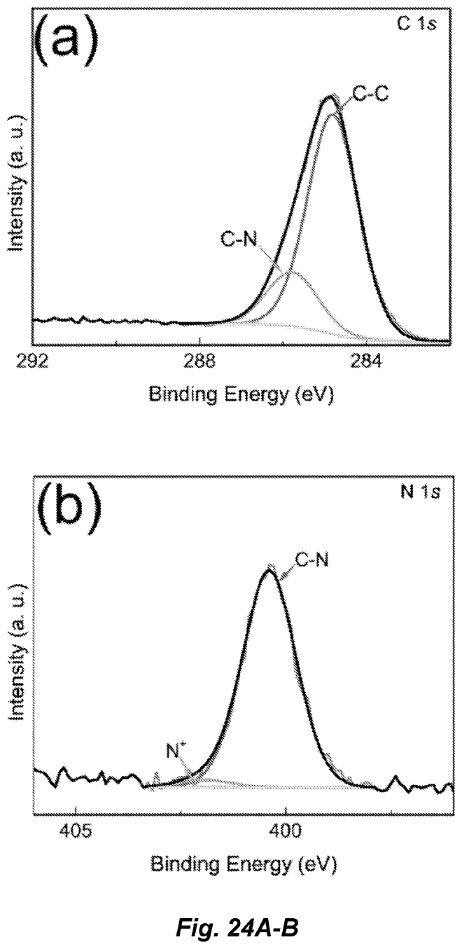

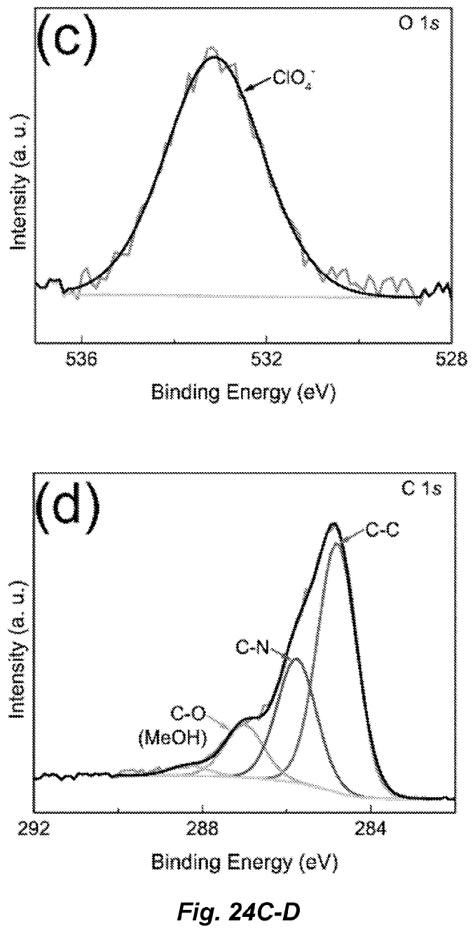

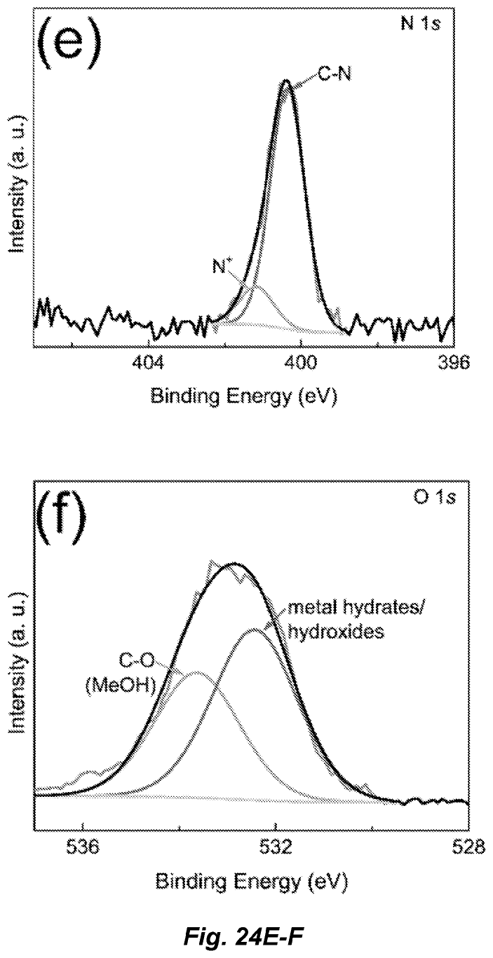

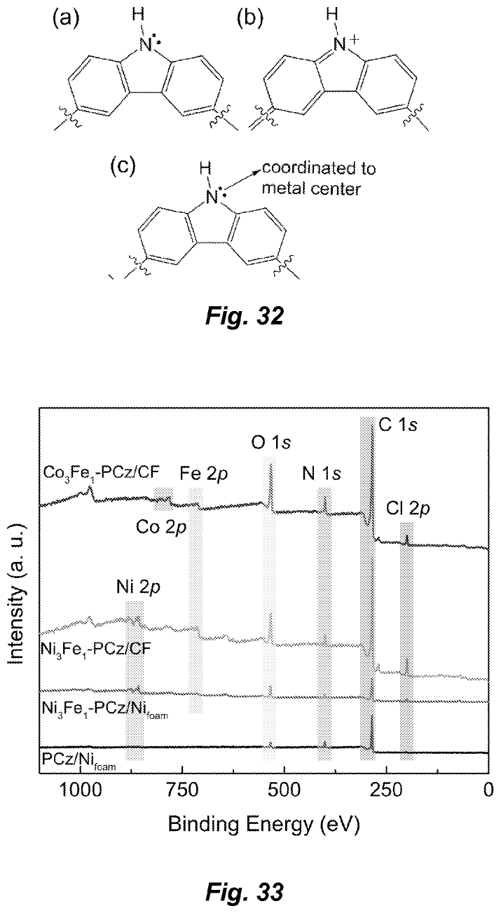

FIG. 24 shows the C, N, and O regions of the XPS spectra of PCz/Ni_{foam} (A-C) and Ni₃Fe₁-PCz/Ni_{foam} after (D-F). The C is region of PCz/Ni_{foam} (FIG. 24a) contains peaks at 284.8 and 285.8 eV that may be assigned to the sp2 carbons bonded to -carbon and -nitrogen, respectively, in the PCz rings. There is only one signal in the 0 is region at 533.1 eV, that may be assigned to the C104-counter ion resulting from the doping (FIG. 24b). There are two peaks in the N is region in the XPS spectrum of PCz/Ni_{foam} (FIG. 24c), one at 400.4 eV that may be assigned to neutral nitrogen in the polycarbazole rings (FIG. 32a), and a smaller peak at 402.6 eV that may be assigned to N⁺ present because of partial doping of the polymer (FIG. 32b). These tentative assignments are in line with those reported for partially doped PCz in the literature. We cannot rule out the presence of trace MeCN in the PCz/Ni_{foam}.

The new C is peaks in the XPS spectrum of Ni₃Fe₁-PCz/Ni_{foam} (287.0 eV and 288.3 eV) likely arise from methanol in the deposit left over from the coordinative deposition (FIG. 24d). The new peak in the N is region at 401.2 eV may arise from nitrogen bonded to Ni or Fe (FIG. 24e, 32c). This tentative assignment is in-line with polypyridyl-metal complexes in the literature. The peak assigned to N from partially doped PCz in the XPS spectrum of PCz/Ni_{foam} is absent with Ni₃Fe₁-PCz/Ni_{foam}. The 0 is region of the XPS spectrum of Ni₃Fe₁-PCz/Ni_{foam} (FIG. 24f) contains peaks ~533.6 eV that may arise from methanol in the deposit, and peaks at ~532.4 eV that may arise from metal hydrates or hydroxides, consistent with literature assignments. These assignments are tentative because specific reference spectra are not available.

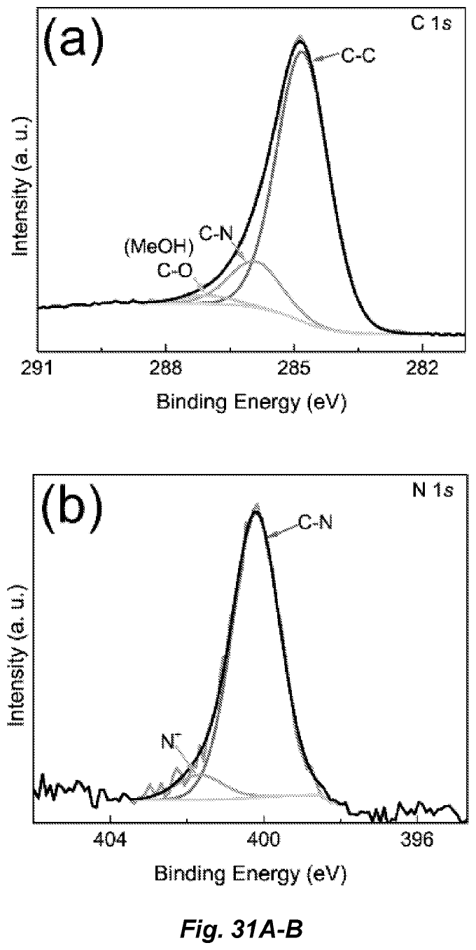

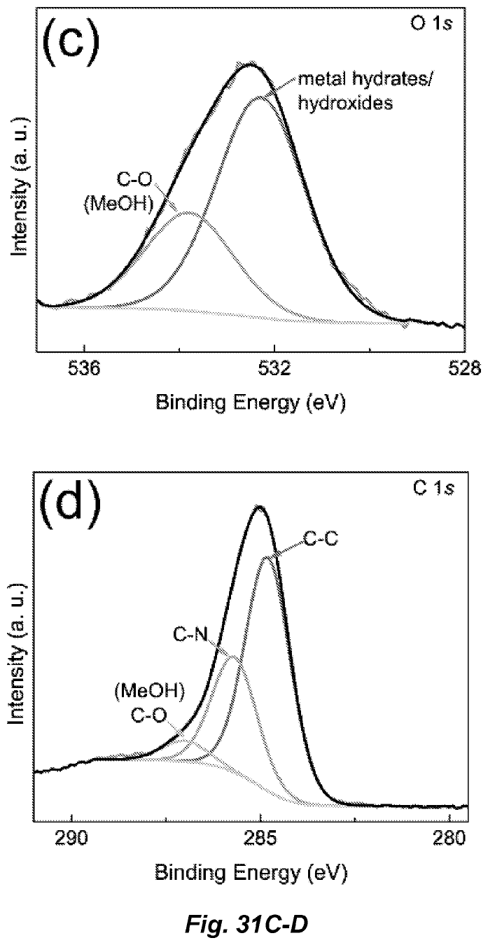

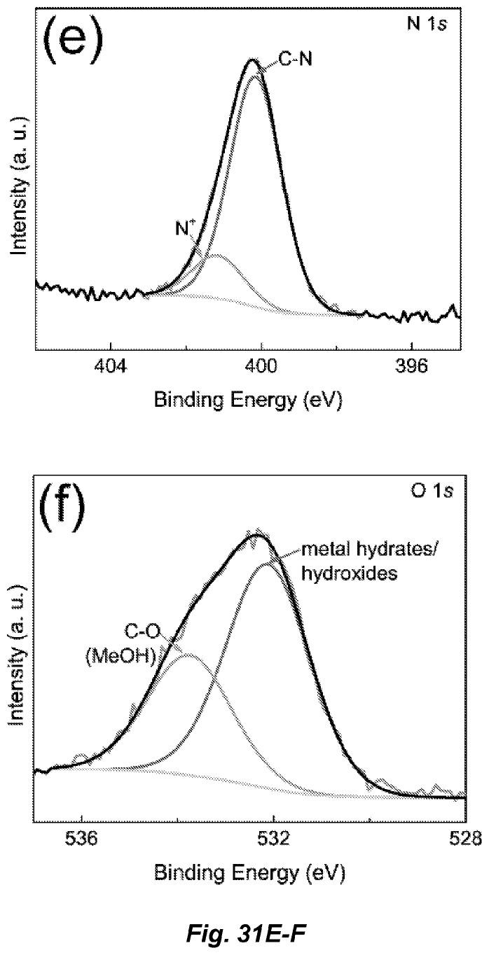

Similar tentative assignments are shown for the C, N, and O regions of the XPS spectra of Ni₃Fe₁-PCz/CF and Co₃Fe₁-PCz/CF (FIG. 31a-c, and FIG. 31d-f). The XPS survey data is shown in FIG. 33.

### Example 18. FTIR Identification

For polycarbazole on carbon paper, the bands present at 728, 755, 800, and 880 cm⁻¹ relate to the C—H bonds. An intense peak at 1100 cm⁻¹ corresponds to ClO₄⁻ ions. Moreover, the peak at 1238 cm⁻¹ represents the N—H stretching. A C═C peak locates positions at 1449 and 1461 cm⁻¹. The peak at 1605 cm⁻¹ is the C—C peak. A broad peak at 3280 cm⁻¹ may result from N—H stretching. The proof for 3, 6 polycarbazole is the peak at 856 cm⁻¹. The peak at 1554 cm⁻¹ is a ring vibration band characteristic of the (partially) oxidized (doped) PCz. The band that appeared at approximately ~3250 cm⁻¹ is assigned to O—H stretching vibrations. After soaking in MeOH with metal Chloride hydrates salts, washing and drying in the air for 24 h, peaks at 1100 and 1554 cm⁻¹ disappear, meaning the absence of ClO₄⁻ ions and reduced (undoped) PCz. In addition, a higher intensity broad peak around 3400 cm⁻¹ represents the presence of Ni salt, and a new peak at 733 cm⁻¹ represents the Fe—O bond.

### Example 19. Chemical and Electrochemical Stability Tests of Polycarbazole (PCz)

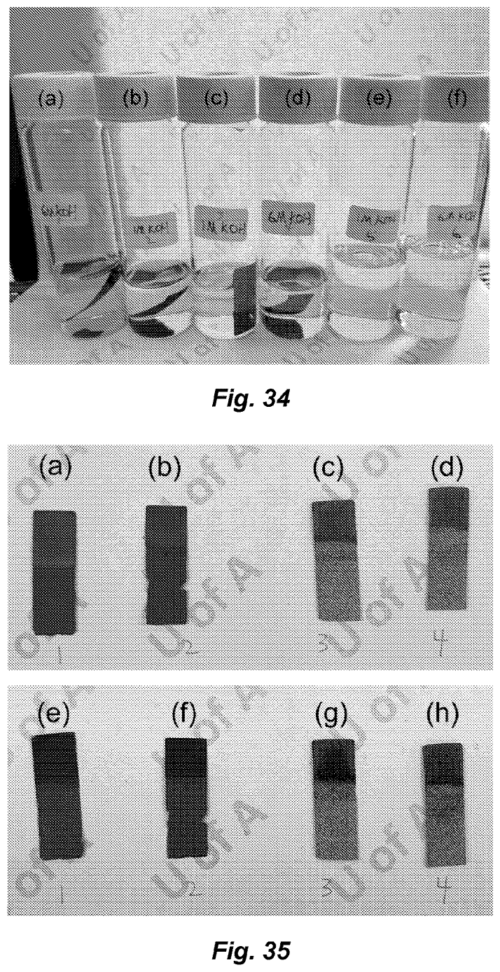

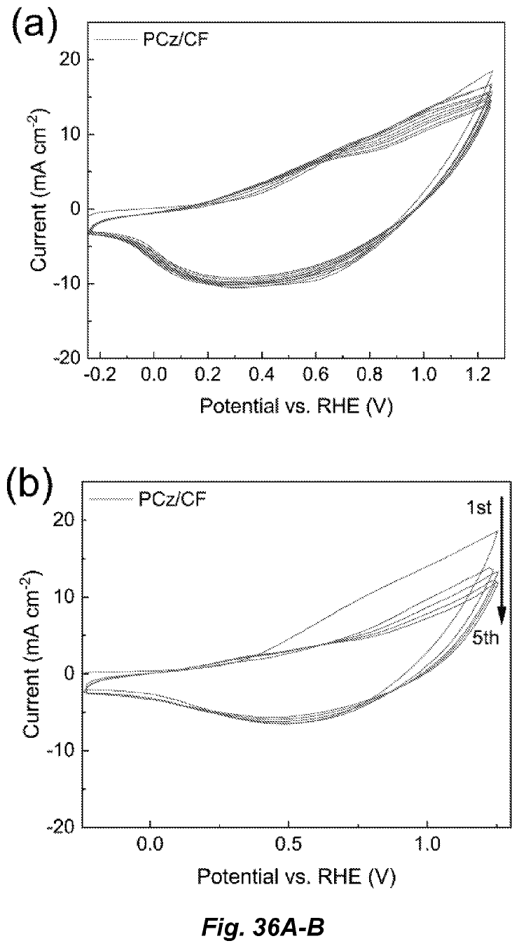

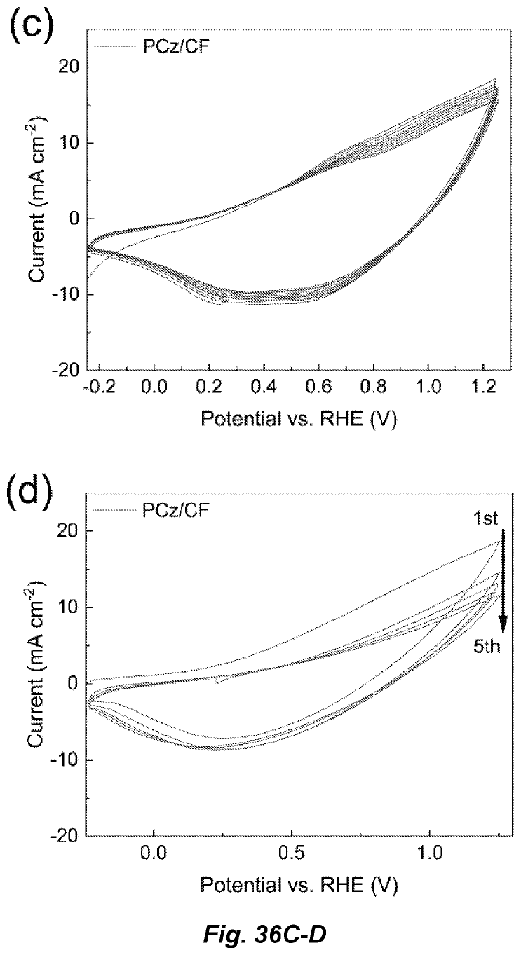

To examine whether polycarbazole is chemically stable in the alkaline OER conditions or not, carbazole is polymerized on carbon fiber paper and Ni foam electrodes first, then soaked in 1 M KOH and 6 M KOH for 240 h at room temperature. As shown in FIG. 34, there are no precipitates present or color change of the KOH solution after 240 h soaking, meaning the PCz is stable to dissolution under the alkaline conditions. Furthermore, after 15 CVs in acetonitrile, the color of PCz changes from brown (undoped) back to dark green (doped), indicating that the electrochemical properties of PCz had not significantly changed, and the PCz remained on the electrode surface (FIG. 35). The CVs of PCz on CF after 240 h soaking in 1.0 and 6.0 M KOH were not significantly different than before (FIG. 36). We note that the anion in the polymer would have changed from perchlorate to hydroxide, some surface restructuring inevitably occurring during the long-term exposure to base, and the stability of the CF support to base is unknown under these conditions. Regardless, these findings, along with the stability of the operating OER electrode in 6M KOH, 85° C., and 120h, strongly indicate that polycarbazole is chemically stable under alkaline OER conditions.

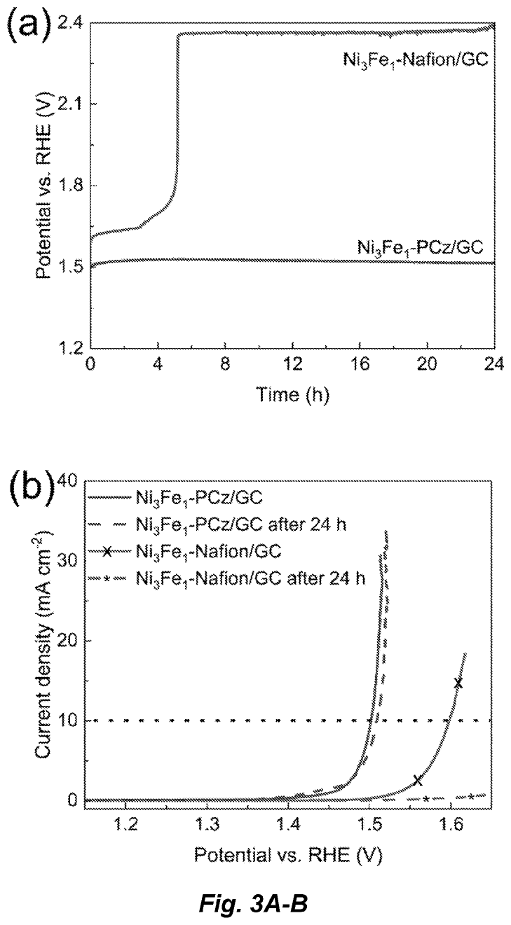

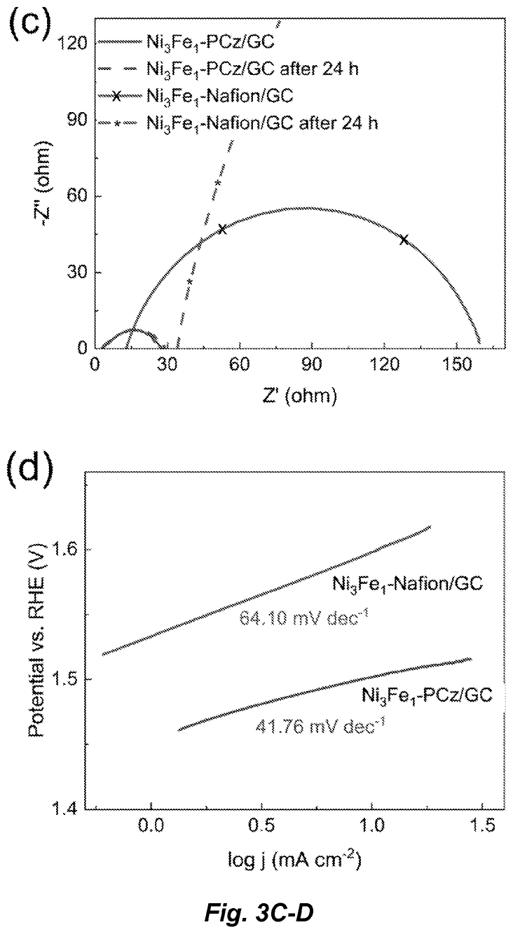

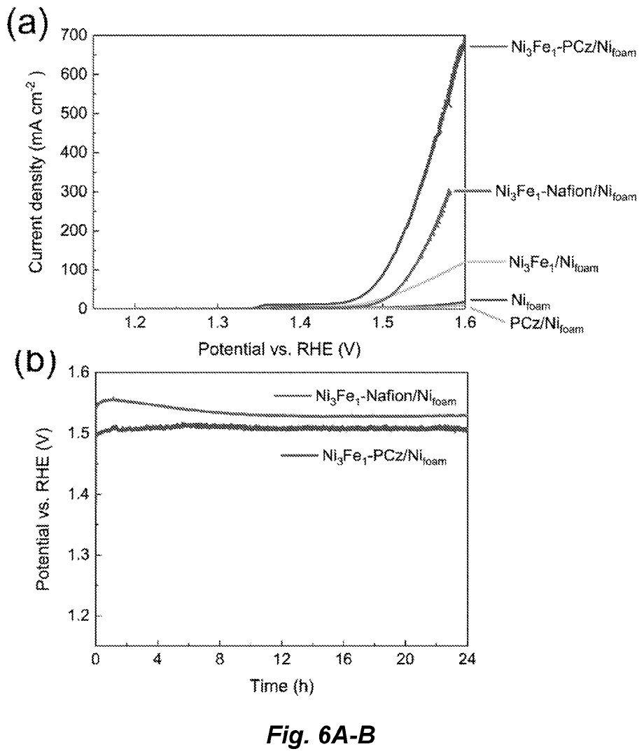

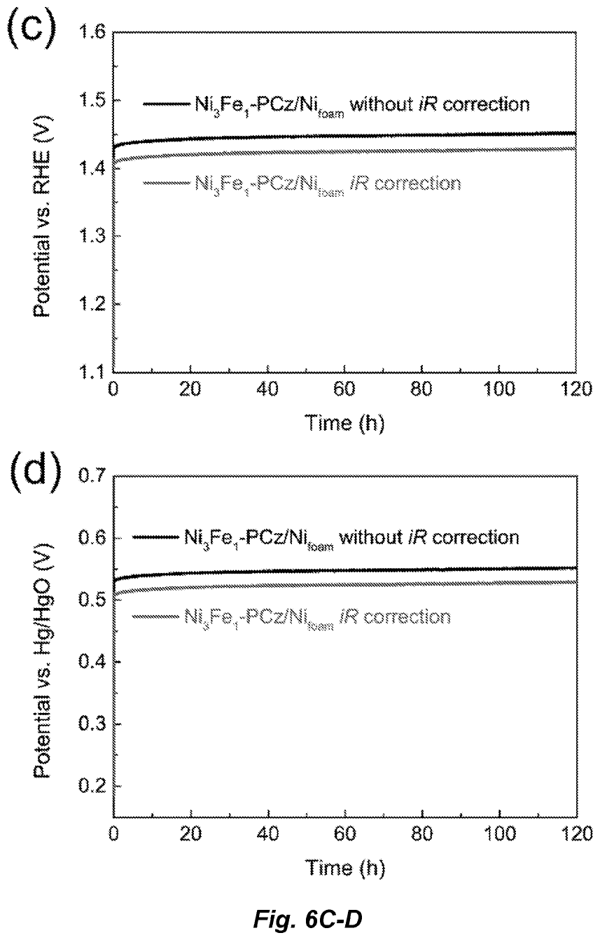

Next, the electrochemical stability of PCz is checked by the galvanostatic tests on GC, CF, and Ni_{foam} with Ni₃Fe₁. Notably, If the binder is not electrochemically stable, the performance of electrodes for OER will drop. The Ni₃Fe₁ with Nafion binder is only electrochemical stable on the Ni_{foam} electrode in this paper (FIG. 6b). The other Nafion binder on GC (FIGS. 3a,b; 14a,b) and CF (FIGS. 15a,b) fail to pass the galvanostatic tests. Impressively, all electrodes with PCz as a binder show good electrochemical stability during the OER tests (FIGS. 3a, 6b, 14a, 15a), and the CVs (FIGS. 3b, 14b, 15b, 29) change a little before and after the galvanostatic tests.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms, wherein the ring skeleton comprises a 5-membered ring, a 6-membered ring, two 5-membered rings, two 6-membered rings, or a 5-membered ring fused to a 6-membered ring.

The term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, haloalkyl, hydroxyalkyl, aryl, heteroaryl, heterocyclyl, cycloalkyl, alkanoyl, alkoxycarbonyl, amino, alkylamino, dialkylamino, carboxyalkyl, alkylthio, alkylsulfinyl, and alkylsulfonyl. Substituents of the indicated groups can be those recited in a specific list of substituents described herein, or as one of skill in the art would recognize, can be one or more substituents selected from alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Suitable substituents of indicated groups can be bonded to a substituted carbon atom include F, Cl, Br, I, OR′, OC(O)N(R′)₂, CN, CF₃, OCF₃, R′, O, S, C(O), 30 S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂NHC(O)R′, N(R′)N(R′)C(O)R′, N(R′)N(R′)C(O)OR′, N(R′)N(R′)CON(R′)₂, N(R′)SO₂R′, N(R′)SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen or a carbon-based moiety (e.g., (C₁-C₆)alkyl), and wherein the carbon-based moiety can itself be further substituted. When a substituent is monovalent, such as, for example, F or Cl, it is bonded to the atom it is substituting by a single bond. When a substituent is divalent, such as O, it is bonded to the atom it is substituting by a double bond; for example, a carbon atom substituted with O forms a carbonyl group, C═O.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

In various embodiments, the ends of the copolymer (i.e., the initiator end or terminal end), is a low molecular weight moiety (e.g. under 500 Da), such as, H, OH, OOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer.

The term “electrocatalyst” refers to a catalyst that participates in electrochemical reactions. Electrocatalysts function at electrode surfaces, for example, to catalyze the conversion of water to oxygen.

### Statements of the Technology.

1. An electrode comprising an electrically conductive substrate that supports a coating of an electropolymerized carbazole doped with one or more ions of iron and one or more ions of another transition metal.
2. The electrode of statement 1, wherein the electropolymerized carbazole comprises polycarbazole (PCz).
3. The electrode of statement 1 or 2, wherein the one or more ions of iron are iron(II), iron(III), or both iron(II) and iron(III).
4. The electrode of any one of statements 1-3, wherein the one or more ions of another transition metal have oxidation states of +1, +2, +3, +4, or both +2 and +3. 5. The electrode of any one of statements 1-4, wherein metal ions of the one or more ions of another transition metal are period-4 metal ions.
6. The electrode of any one of statements 1-5, wherein metal ions of the one or more ions of another transition metal are nickel ions or cobalt ions.
7. The electrode of any one of statements 1-6, wherein metal ions of the one or more ions of another transition metal are nickel(II), nickel(III), or both nickel(II) and nickel(III).
8. The electrode of any one of statements 1-7, wherein the one or more ions of iron and the one or more ions of another transition metal have a relative stoichiometric ratio according to formula I:

MₓFe_{y} (I),
wherein M is an ion of Ni or Co, x is 1-9, and y is 1.
9. The electrode of statement 8, wherein the stoichiometric ratio is Ni₃Fe₁.
10. The electrode of any one of statements 1-9, wherein the electrically conductive substrate comprises carbon fiber paper (CF), nickel foam (Ni_{foam}), or glassy carbon (GC).
11. The electrode of any one of statements 1-10, wherein the electropolymerized carbazole is an electrically conductive polymer comprising repeating units of a carbazole monomer, wherein the repeating units are partially oxidized.
12. The electrode of statement 11, wherein the one or more ions of iron are iron salts, wherein a nitrogen lone pair of electrons of one carbazole monomer is coordinated to an iron cation of an iron salt, and a nitrogen cation of one oxidized carbazole monomer is paired with an anion of the iron salts; and
   wherein the one or more ions of another transition metal are period-4 transition metal salts, wherein a nitrogen lone pair of electrons of a second carbazole monomer is coordinated to a metal cation of a period-4 transition metal salt, and a nitrogen cation of a second oxidized carbazole monomer is paired with an anion of a period-4 transition metal salt.
13. The electrode of any one of statements 1-12, further comprising an alkali base that is paired with the electrically conductive polymer.
14. The electrode of any one of statements 1-13, wherein the doped electropolymerized carbazole comprises sequential blocks of formula (II):

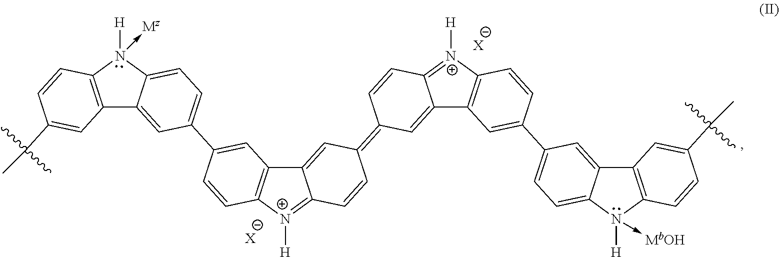

wherein;
M^{z} is each independently a cation of iron or nickel; or M^{z} is each independently a cation of iron or cobalt; M^{b} is an alkali metal such as KOH; and X⁻ is a counter anion such as Cl⁻; wherein one or more phenyl rings of the carbazole moieties of the blocks of formula II are optionally substituted.
15. A method for preparing an electrode according to any one of statements 1-14, comprising:
   a) electropolymerizing carbazole onto an electrically conductive substrate to form an electrocoated polycarbazole substrate;
   b) doping the electrocoated polycarbazole substrate in an inert atmosphere with an iron salt and a different period-4 transition metal salt to form a doped polycarbazole substrate, wherein the one or more ions of iron and the one or more ions of another transition metal have a relative stoichiometric ratio according to formula I:

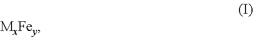

wherein x is 1-9 and y is 1; and
c) oxidizing the doped polycarbazole substrate wherein ions of the iron salt are oxidized from iron(II) to iron(III); thereby forming the electrode.
16. The method of statement 15, wherein M is nickel(II), nickel(III), or both nickel(II) and nickel(III).
17. The method of statement 15 or 16, wherein M is cobalt(II), cobalt (III), or both cobalt (II) and cobalt (III), or each M is independently cobalt (II) or cobalt (III).
18. The method of any one of statements 15-17, wherein X is 3 and Y is 1 for the stoichiometric ratio represented as MₓFe_{y}, wherein formula I is M₃Fe₁
19. The method of any one of statements 15-18, wherein the electrode is configured for catalytic electrooxidation of water to oxygen.
20. An electrode comprising an electrically conductive substrate coated with an electrically conductive polymer, the electrically conductive polymer comprising a plurality of iron cations and a plurality of nickel cations; wherein
   a) the electrically conductive polymer comprises repeating units of an optionally substituted carbazole monomer moiety, wherein the repeating units are bonded to each other through an exocyclic covalent bond at a benzo moiety of each internal carbazole monomer moiety, and a plurality of the repeating units are partially oxidized;
   b) nitrogen lone pairs of electrons of one or more carbazole monomer moieties are coordinated to iron cations;
   c) nitrogen lone pairs of electrons of one or more other carbazole monomer moieties are coordinated to nickel cations;
   d) one or more nitrogen cations of oxidized carbazole monomers are paired with anions of iron salts or nickel salts; and
   e) the iron cations and nickel cations are present in a ratio of about 1:3.
21. A method for catalytic electrooxidation of water to oxygen comprising: a) completing an electrical circuit with an electrode according to any one of statements 1-14 as the anode; and b) contacting the electrical circuit with water.
22. The method of statement 21, wherein the water is saltwater.
23. An electrode comprising:
   a) an electrically conductive polymer comprising repeating units of a carbazole monomer, wherein one or more repeating units are bonded to each other through an exocyclic covalent bond at a benzo moiety of the carbazole monomer, and the repeating units are partially oxidized;
   b) an iron salt, wherein a nitrogen lone pair of electrons of a first carbazole monomer is coordinated to an iron cation of the iron salt, and a nitrogen cation of a first oxidized carbazole monomer is paired with an anion of the iron salt;
   c) a nickel salt, wherein a nitrogen lone pair of electrons of a second carbazole monomer is coordinated to a nickel cation of the nickel salt, and a nitrogen cation of a second oxidized carbazole monomer is paired with an anion of the nickel salt,
   wherein the stoichiometric ratio of the iron cation relative to the nickel cation is about 1:3; and
   d) an electrically conductive substrate that supports a coating of the electrically conductive polymer, the iron salt, and the nickel salt.

### Further Aspects of the Technology.

1. An electrode having greater stability for use in an oxygen evolution reaction (OER) wherein the electrode comprises a polycarbazole (PCz) binder that has been doped with an electrocatalyst and deposited on a substrate.

In some embodiments, the electrocatalyst comprises one or more ions of a first transition metal and one or more ions of a second transition metal. In various embodiments, the first transition metal is iron. In various embodiments, the second transition metal is a period-4 metal such as nickel or cobalt that can have oxidation states of +2 or +3. In some embodiments, the electrocatalyst comprises a cation of iron and a cation of nickel or cobalt and wherein the counter ion (X⁻) is OH⁻, O²⁻, or Cl⁻.
2. The electrode of aspect 1, wherein the substrate comprises nickel (Ni) foam.
3. The electrode of aspect 1, wherein the substrate comprises a carbon fiber.
4. The electrode of aspect 1, wherein the substrate comprises a glassy carbon.
5. The electrode of any one of aspects 1-4, wherein the PCz is modified with an active component comprising the formula MₓFe_{y}-PCz/CF wherein M is Ni or Co, x is 1-9, and y is 1. In some embodiments, the stoichiometric ratio of the first transition metal (M¹) and the second transition metal (M²) is represented by formula IA:

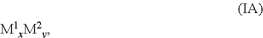

wherein M¹ is an ion of the first transition metal, M² is an ion of the second transition metal, x is 0.01-0.99, and y is 1-x. In some embodiments, M¹ is iron, M² is Ni, x=0.25, and y=0.75.

In some embodiments, the stoichiometric ratio is according to formula IB:

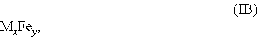

wherein x is 0.01-0.99 and y is 1-x. In some embodiments X is 0.75 and Y is 0.25.
6. The electrode of any one of aspects 1-5, wherein the electrode comprises high activity under harsh conditions (high temperatures, high current density, and high alkalinity).
7. The electrode of any one of aspects 1-6, wherein the electrode comprises redox-active, conductive, polycationic, and coordinating.
8. A method for making a high activity, stable oxygen evolution reaction (OER) electrode comprising: a) depositing a polycarbazole (PCz) layer over a conductive substrate; and b) depositing an electrocatalyst on the PCz-layered substrate.
9. The method of aspect 8, wherein the substrate comprises nickel foam, carbon fiber, or glassy carbon.
10. The method of aspect 8 or 9, wherein deposition comprises using electropolymerization.
11. The method of aspect 10, wherein the electropolymerization comprises cyclic voltammetry.
12. The method of any one of aspects 8-11, wherein the PCz is doped.
13. The method of any one of aspects 8-12, wherein the PCz is modified with an active component comprising the formula MₓFe_{y}-PCz/CF wherein M is Ni or Co, x is 1-9, and y is 1.
14. The method of any one of aspects 8-13, wherein the catalyst is deposited from NiCl₂·6H₂O, FeCl₂·4H₂O, or CoCl₂·6H₂O, in a solvent.
15. The method of aspect 14, wherein a solvent comprises methanol (MeOH) or acetonitrile (MeCN).
16. The method of any one of aspects 8-15, where the electrode is redox-active, conductive, polycationic, and coordinating.
17. The method of any one of aspects 8-16, wherein the depositing is made in an inert gas environment.
18. The method of aspect 17, wherein the inert gas comprises argon, nitrogen, or carbon dioxide.
19. The method of any one of aspects 8-18, wherein the PCz-layered electrode was treated with Ni(II) and Fe(II) in MeOH and then exposed to air.

### Discussion.

FIG. 2b shows Tafel plots for the electrodes. Ni₃Fe₁-PCz/CF has the lowest Tafel slope among the Ni series, again demonstrating its high activity. Tafel slopes have been extensively studied in the literature for the OER. The Tafel slope for Ni₃Fe₁-PCz/CF (~53.5 mV/dec) is generally accepted to indicate that the turnover limiting step is attacked by OH⁻(aq) on a surface oxide. This interpretation suggests that one role of the PCz may be to enhance the attack by OH—, perhaps by increasing the local [OH⁻] (FIG. 1c). This interpretation requires detailed mechanistic studies to confirm. The slopes for the cobalt-based electrodes also indicate that the attack by hydroxide is turnover limiting.

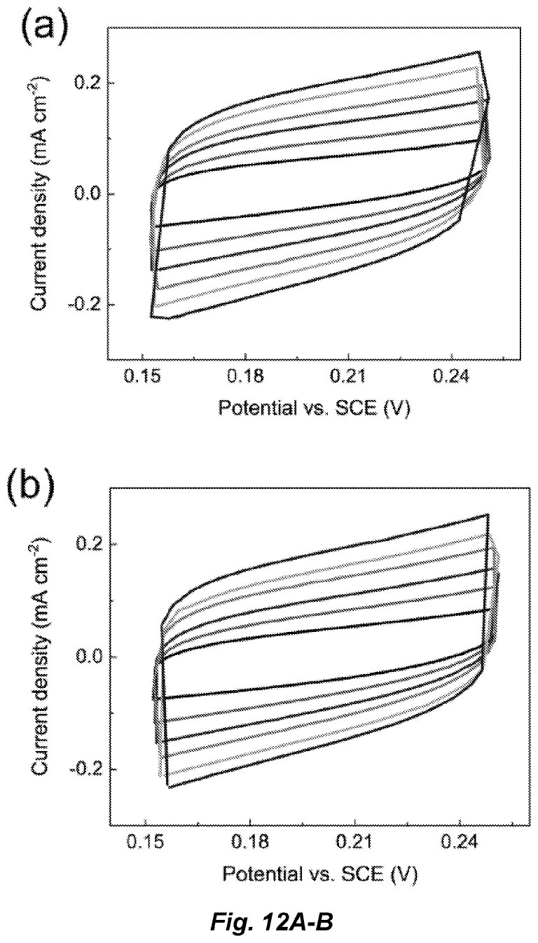

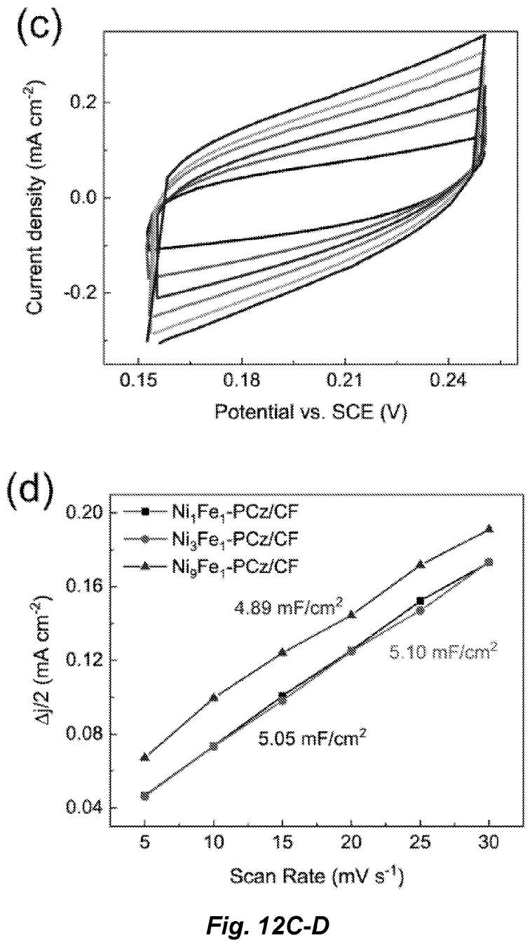

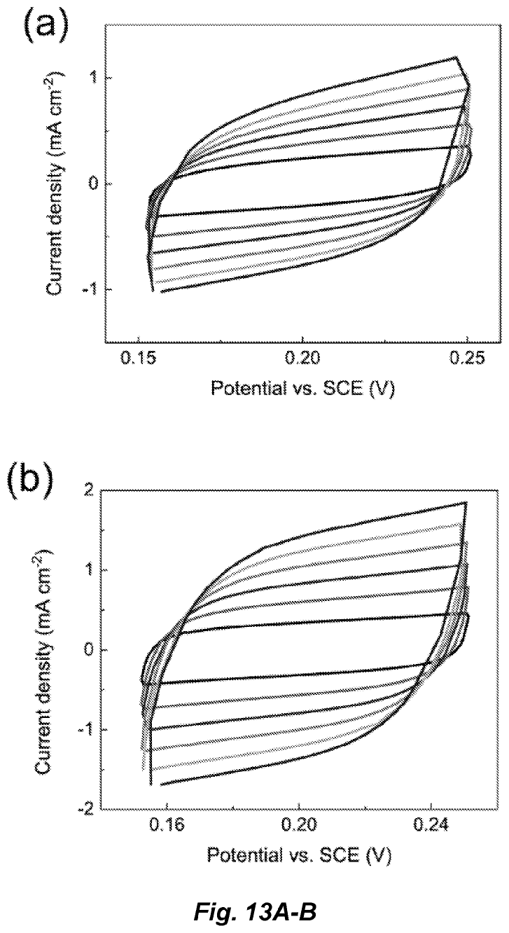

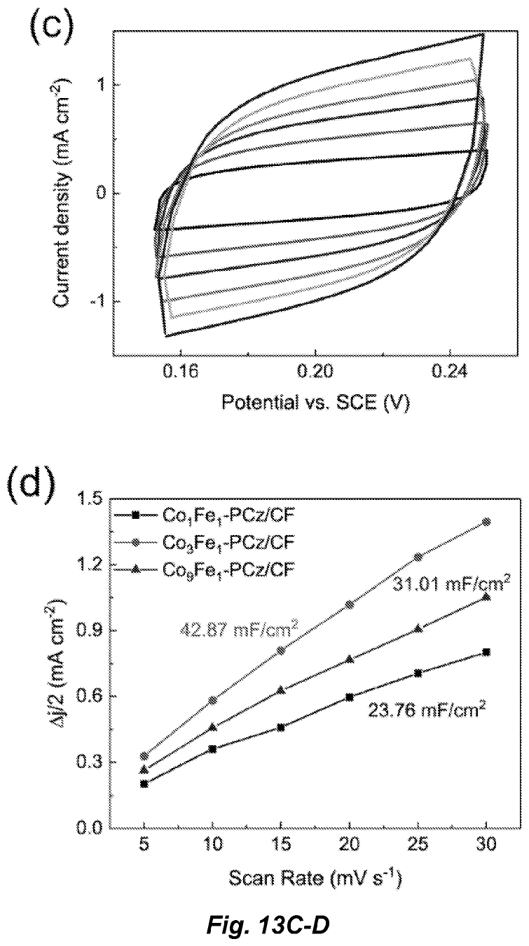

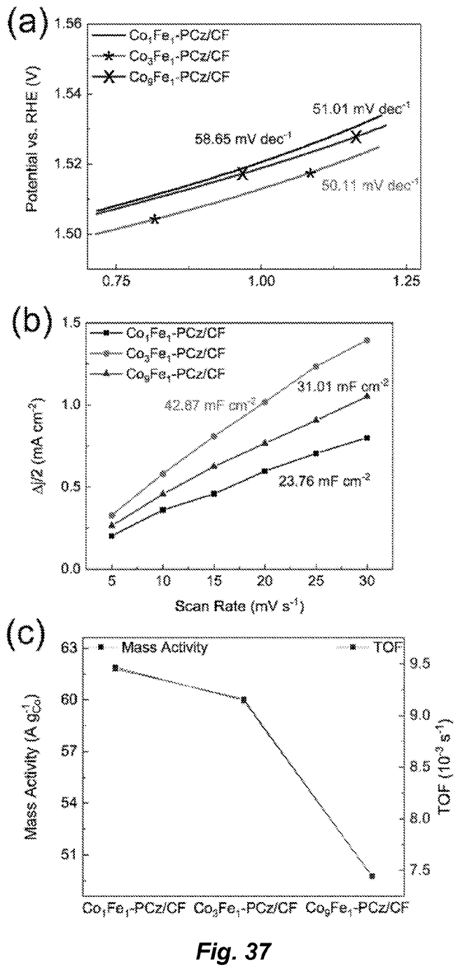

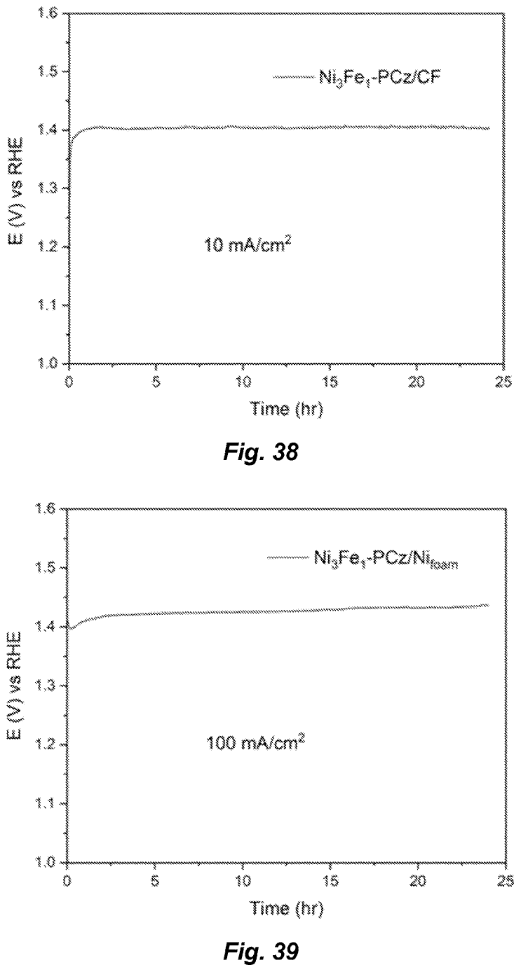

The electrochemical surface areas (ECSA's) of the electrodes were investigated by comparing their double-layer capacitance (C_{dl}) in the non-Faradaic region (FIGS. 2c and FIGS. 12, 13, 37). Table 2 summarizes the results. The catalyst with the highest activity in this study, Ni₃Fe₁-PCz/CF, also has among the lowest C_{dl}. The high OER activity of the Ni₃Fe₁-PCz/CF is therefore more due to the intrinsic activity of the catalyst sites and less due to differences in ECSA.

High geometric activities with low catalyst mass loadings are desired in commercial systems to reduce cost and to simplify electrode preparation. FIG. 2d shows the mass activities (A g⁻¹(Ni+Fe)) of the NiₓFe_{y}-PCz/CF electrodes at 1.454 V vs. RHE, when the current density is 10 mA cm⁻² over Ni₃Fe₁-PCz/CF (FIG. 2a). Again, Ni₃Fe₁-PCz/CF was significantly the most active CF-based electrode prepared in this study, with mass activity=99.73 A g⁻¹. FIG. 11 plots overpotentials at 10 mA cm⁻² vs. catalyst mass loading for the most active earth-abundant OER catalysts in the literature. The Ni₃Fe₁-PCz/CF electrode is among those with the best combination of low overpotentials and mass loadings. A similar analysis was also conducted using CoₓFe_{y}-PCz/CF electrodes.

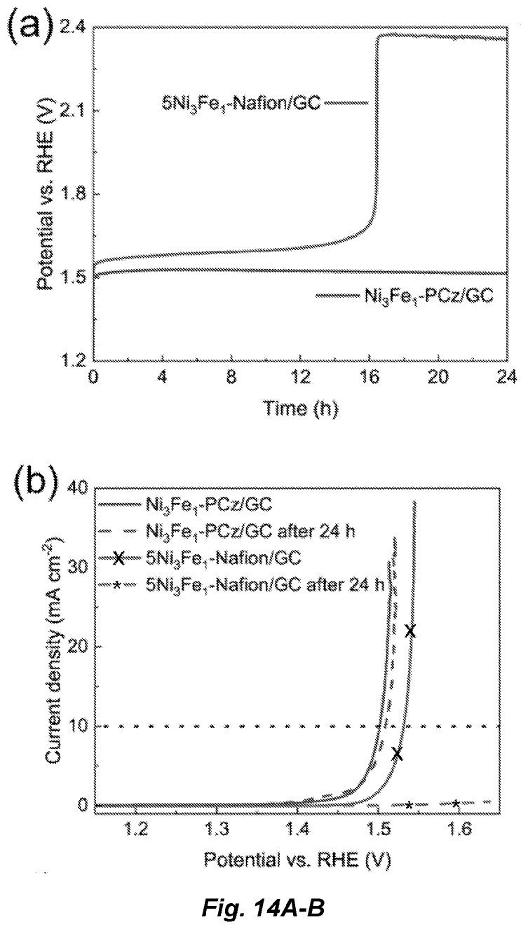

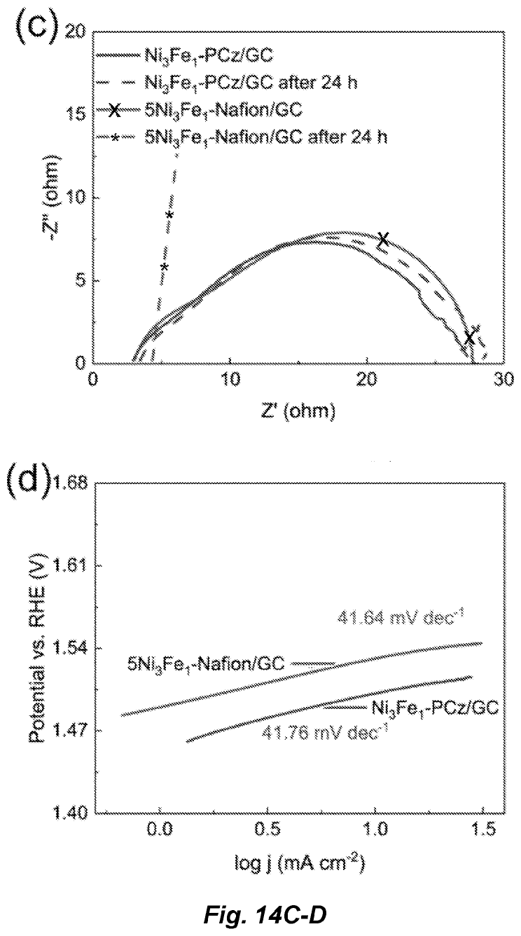

FIGS. 3 and 14 compare the OER activities of flat, well-defined glassy carbon electrodes (GC) with the same Ni₃Fe₁ loadings and prepared in the same manner with either electropolymerized carbazole or Nafion binders. This in-house, direct, well-defined comparison eliminates any effects of surface area and diffusion encountered with carbon felt. FIG. 3a shows that during the galvanostatic OER (10 mA cm⁻², 1.0 M KOH), the Nafion-based electrode, Ni₃Fe₁-Nafion/GC, operated at significantly higher potentials and it suffered a catastrophic failure after~5 h. In contrast, the Ni₃Fe₁-PCz/GC operated at much lower potentials and was stable over the 24 h run, demonstrating that PCz is electrochemically stable and promotes the OER under these conditions.

FIG. 3b compares the LSV OER (1 M KOH) reactions over the Nafion- and PCz-based electrodes. The onset potential was much lower over the Ni₃Fe₁-PCz/GC electrode, and the overpotential at 10 mA cm⁻² was only 272 mV. The overpotential at 10 mA cm⁻² over the Nafion-based electrode was 368 mV. FIG. 14b shows that the LSV overpotential at 10 mA cm⁻² over Ni₃Fe₁-PCz/GC (272 mV) was even lower than a Nafion-based electrode with 5× the mass loading of Ni₃Fe₁(301 mV).

FIG. 3c shows the Nyquist plots (at 0.5 V vs. SCE) for the PCz- and Nafion-based electrodes before and after 24 h galvanostatic OER in 1 M KOH. As expected, the high-frequency resistance of Ni₃Fe₁-PCz/GC is much lower than the Nafion-based system, strongly indicating that the polycarbazole is electronically conductive at this potential. Furthermore, there was little change in the Nyquist plot of the Ni₃Fe₁-PCz/GC electrode after the 24 h galvanostatic OER, again showing the stability of the polycarbazole binder under these conditions.

As stated above, the Nafion-based electrode underwent catastrophic failure after ~5 h of the galvanostatic OER. While detailed investigations are required to determine the exact mechanisms responsible for the plots, it is clear that the PCz-binder significantly enhances and stabilizes the OER reaction. FIG. 14c shows that the initial Nyquist plots of the PCz-based electrodes and that of a Nafion-based electrode with 5× the mass loading of electrocatalyst (Ni₃Fe₁) were similar, but the higher loading Nafion-based electrode still underwent catastrophic failure during the galvanostatic OER.

FIG. 3d compares the Tafel slopes of the PCz- and Nafion-based glassy carbon electrodes with the same catalyst loadings. The Tafel slope (41.76 mV dec-1) over Ni₃Fe₁-PCz/GC was significantly lower (41.76 mV dec⁻¹) than over the Nafion-based electrode (64.10 mV dec⁻¹), suggesting again that PCz enhances the OER reaction. FIG. 14d shows that the Tafel slope of the PCz electrode (41.76 mV dec⁻¹) is similar to that of the Nafion-based electrode with 5× the mass loading of electrocatalyst (41.64 mV dec⁻¹). We note that the 5× mass loading of Ni₃Fe₁ on GC can relatively stable until ~16 h. The 5× higher loading of catalyst reduced the applied potential required to achieve the same current density (10 mA cm⁻²), improving its stability.

Taken together, these results demonstrate that the polycarbazole binder increases both the OER performance and stability of Ni₃Fe₁-PCz/GC. FIG. 15 shows similar enhancements in OER performance in PCz vs Nafion electrodes on CF. Further, control experiments show there were no significant changes in the physical appearance of PCz on CF or Ni_{foam} after soaking for 10 days in 6 or 1 M KOH. Moreover, chemical and electrochemical stability tests of PCz are described in detail above.

Structure of the Ni₃Fe₁-PCz/CF.

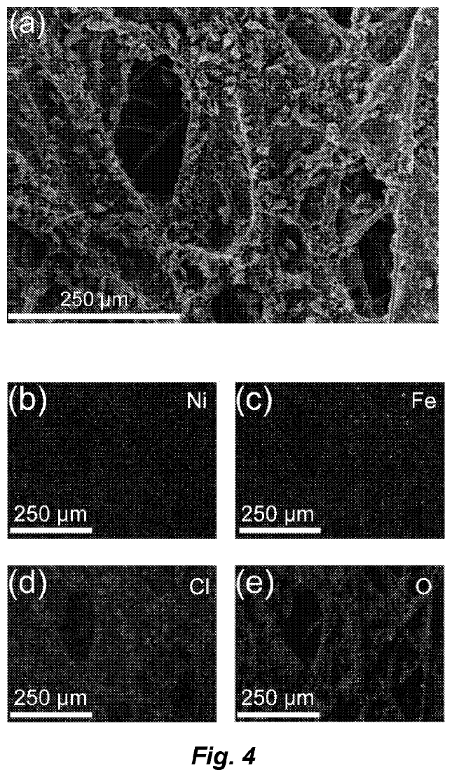

FIG. 1b shows the FTIR of the Ni₃Fe₁-PCz/CF deposit. Detailed assignments of other peaks in the FTIR based upon comparisons to the literature are provided in the EXAMPLES. Notably, the large perchlorate signal in the FTIR of the unmetalled polymer, PCz/CF, is absent in the deposit. Thus, the polycarbazole was either reduced during the deposition, or the perchlorate was exchanged with chloride. We note that the peak at 1554 cm⁻¹ in the FTIR of PCz/CF, which was assigned to doped (partially oxidized) PCz, is also absent, suggesting that the oxidized polycarbazole was reduced at some stage during the deposition and handling. The uniform distributions of Cl and O observed in the EDX elemental mapping of Ni₃Fe₁-PCz/CF (FIGS. 4d and 4e) are, therefore, due to the presence of Cl⁻ and H₂O, OH⁻, or MeOH. The large broad peak at 3323 cm⁻¹ in the FTIR spectrum of Ni₃Fe₁-PCz/CF is absent in the spectrum of PCz/CF. This peak is due to the presence of (Ni/Fe)—H₂O or —OH groups in the deposit. Moreover, the peak at 733 cm⁻¹ represents an Fe—O bond.

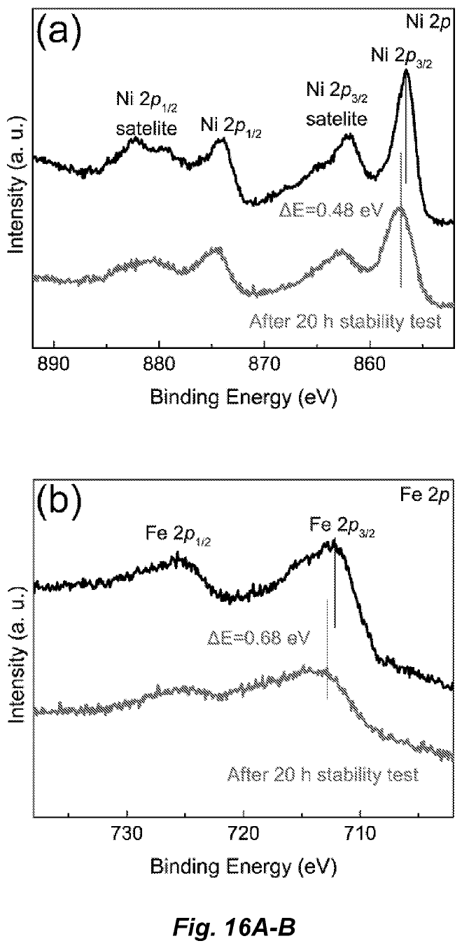

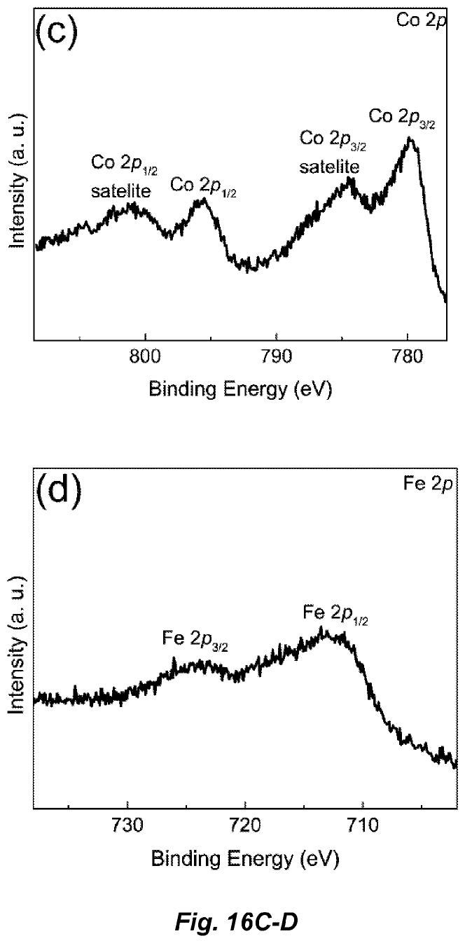

FIG. 16 shows the high-resolution XPS spectra in the Ni 2p and Fe 2p regions for the Ni₃Fe₁-PCz/CF electrode. The 873.8 and 856.5 eV peaks correspond to Ni²p_{1/2} and 2p_{3/2}, indicating that the oxidation state of Ni is +2.41 The Fe 2p peaks at 712.1 and 725.4 eV correspond to Fe(III), showing that, as expected, the Fe(II) was oxidized while the samples were left in the air overnight. There were no significant changes to the XPS after the 20 h galvanostatic OER, again demonstrating the stability of the catalyst. The Ni²p_{1/2} and Ni²p_{3/2} peaks shifted by ~0.48 eV in the positive direction, and the Fe²p_{1/2} and Fe²p_{3/2} shifted by ~0.68 eV after the 20 h OER. These slight shifts to higher energy are a common phenomenon for OER catalysts.

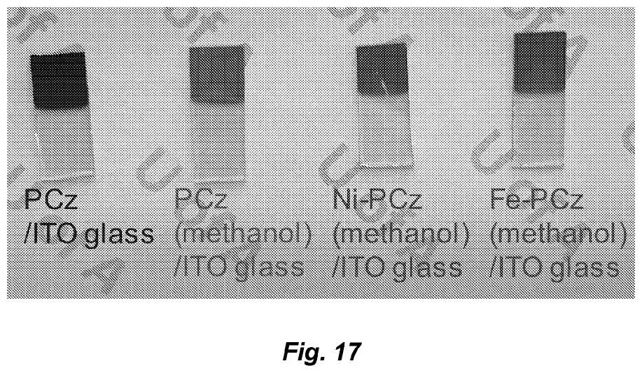

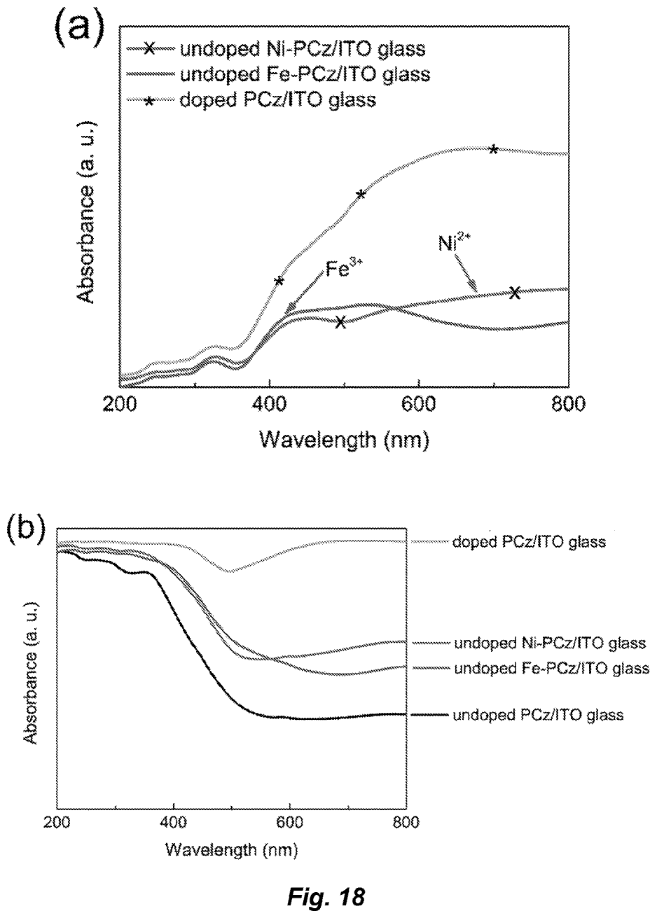

The absorbance by the CF support interfered with UV-vis studies of Ni₃Fe₁-PCz/CF. As a result, control UV-vis experiments were carried out with polycarbazole on ITO slides. FIG. 17 showed that the doped polycarbazole is indeed reduced to the undoped form after soaking overnight in methanol, as indicated by the FTIR studies above. The spectra of Ni-PCz/ITO, and of Fe-PCz/ITO (FIG. 18) contained new peaks due to interactions between the polycarbazole and the Ni and Fe ions during the coordinative deposition. The exact nature of these interactions requires further study.

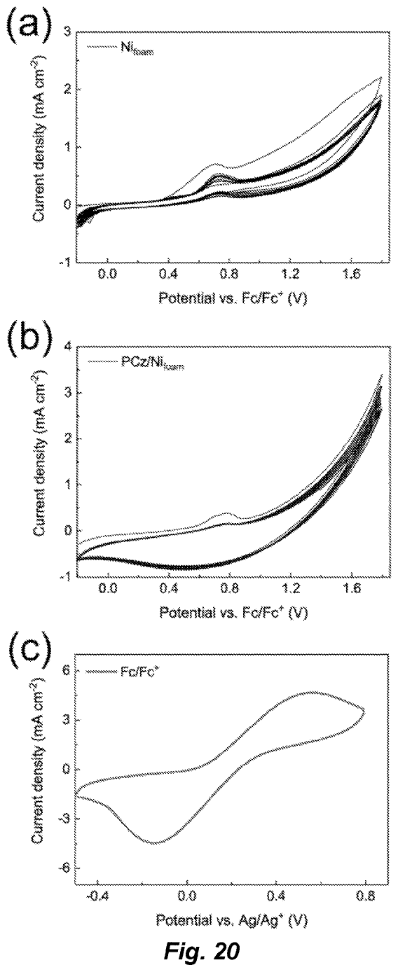

Ni, Fe on PCz coated Ni foam electrode. We next prepared the Ni₃Fe₁-PCz catalyst over Ni foam, an effective support for reported NiFe OER catalysts (FIG. 19). FIG. 20 shows the CV of the isolated PCz/Ni_{foam} (0.1 M n-Bu₄N⁺PF₆⁻ in CH₂C₁₂) that contains anodic waves due to oxidation of PCz and the Ni surface, as well as reductive waves of the doped PCz. To our knowledge, this is the first report of the electropolymerization carbazole over Ni foam.

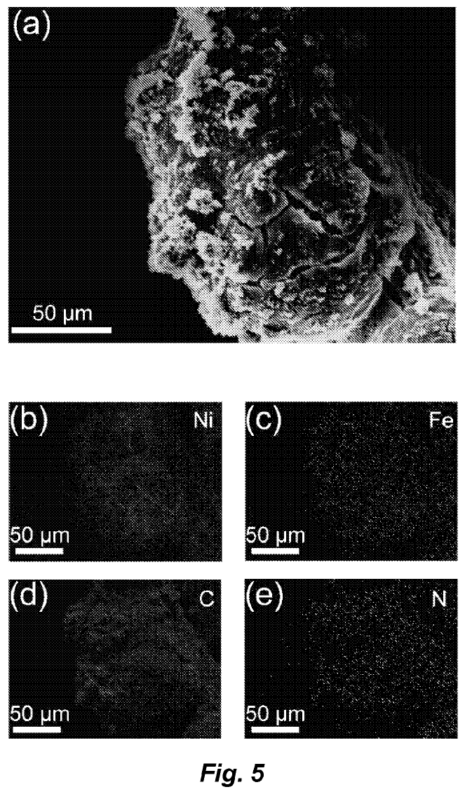

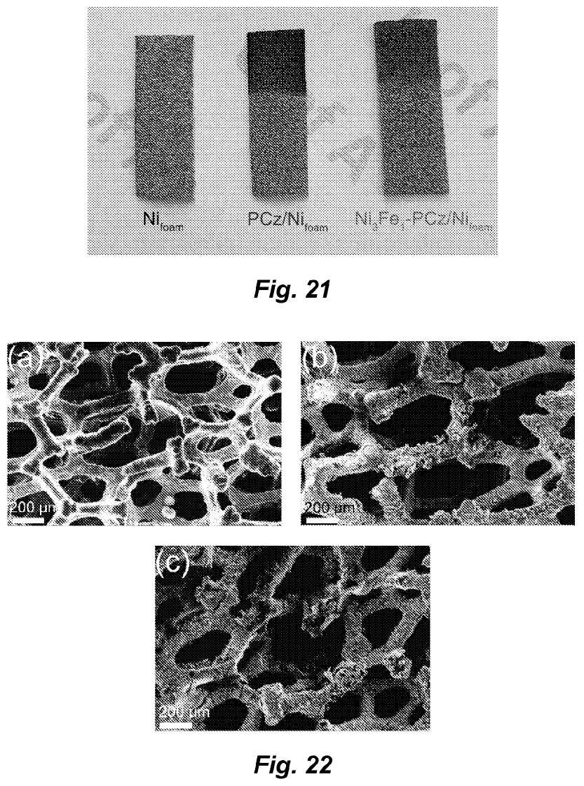

The PCz/Ni_{foam} electrode was treated with Ni(II) and Fe(II) in MeOH and then exposed to air, as was described previously (FIG. 21). FIG. 22 shows the SEM of Ni foam, PCz/Ni_{foam}, and Ni₃Fe₁-PCz/Ni_{foam}. The SEM of PCz/Ni_{foam} clearly shows a thick layer of PCz on Ni foam. The coverage of the Ni strands by the thick film of polycarbazole appears uniform, with some cracks and filaments of polymer that grew from the surface. The SEM recorded after the coordinative deposition of Ni₃Fe₁ (Ni₃Fe₁-PCz/Ni_{foam}) shows that the morphology of the deposit is largely the same as PCz/Ni_{foam}, perhaps with fewer filaments of polymer growing from the surface. EDX elemental mapping (FIG. 5) shows a uniform distribution of N, Fe, and C throughout the deposit. The signal from the underlying Ni foam made conclusions about the distribution of Ni(II) unreliable.

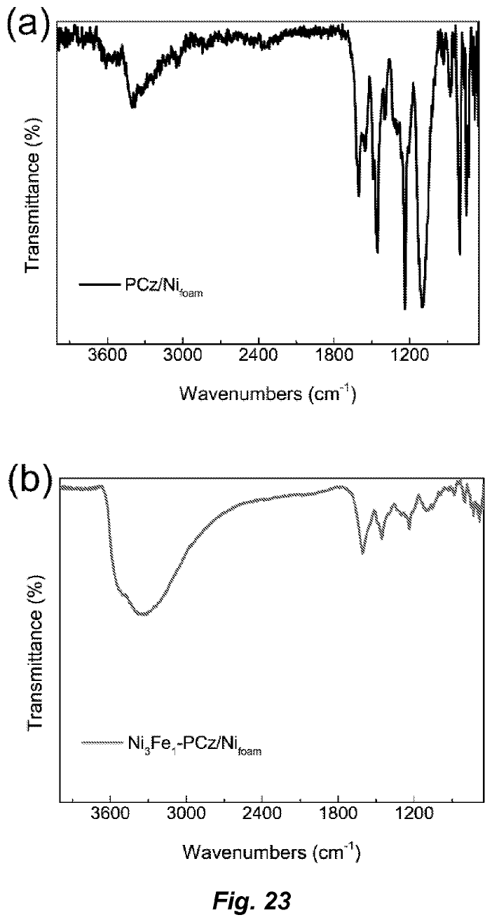

The FTIR of the PCz/Ni_{foam} (FIG. 23) contains peaks for the perchlorate anion and doped polycarbazole, the same as PCz/CF. The FTIR spectrum of Ni₃Fe₁-PCz/Ni_{foam} (FIG. 23b) was quite similar to that of Ni₃Fe₁-PCz/CF.

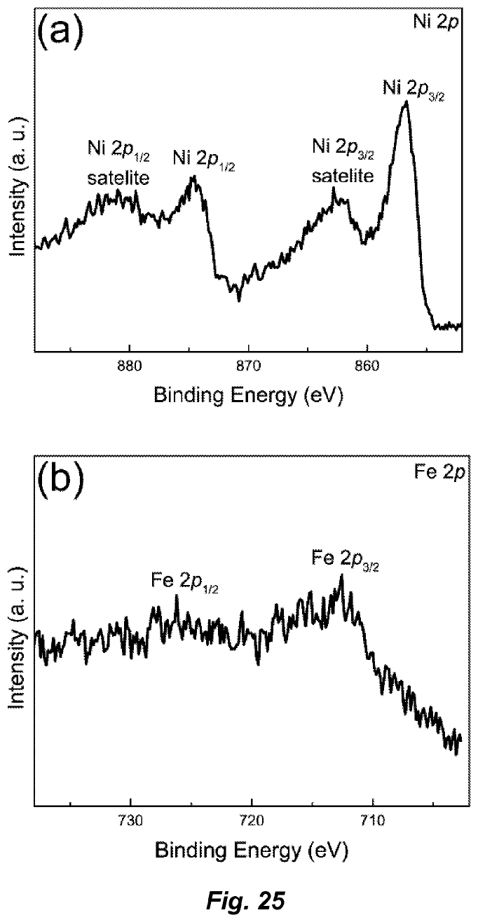

The XPS of spectrum PCz/Ni_{foam} was typical for doped polycarbazole (FIG. 24). Furthermore, the Ni²p_{1/2} and Ni²p_{3/2} peaks (874.5 and 856.6 eV) and the Fe²p_{1/2} and Fe²p_{3/2} peaks (726.2 and 712.5 eV) in the XPS spectrum of Ni₃Fe₁-PCz/Ni_{foam} were only of slightly higher energy than those in Ni₃Fe₁-PCz/CF (FIG. 25).

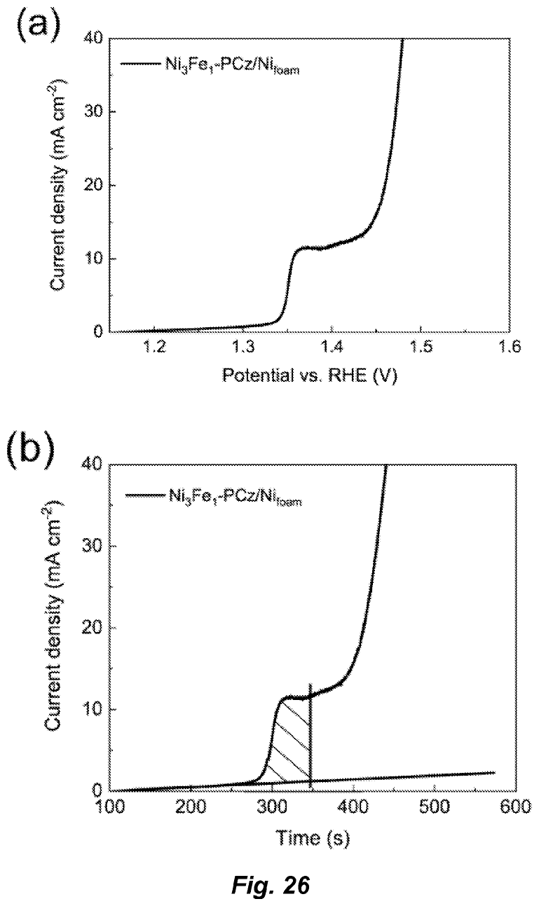

The amount of electrochemically accessible Ni in the Ni₃Fe₁-PCz/Ni_{foam} deposit, as estimated from the Ni(II) to Ni(III) peak in the LSV (FIG. 26), is ~298 pg cm⁻². This value, however, contains contributions from the Ni foam support. The amount of Fe in the Ni₃Fe₁-PCz/Ni_{foam} deposit was 43 pg cm⁻² (ICP-OES), similar to the Ni₃Fe₁-PCz/CF deposit (~36 μg cm⁻²).

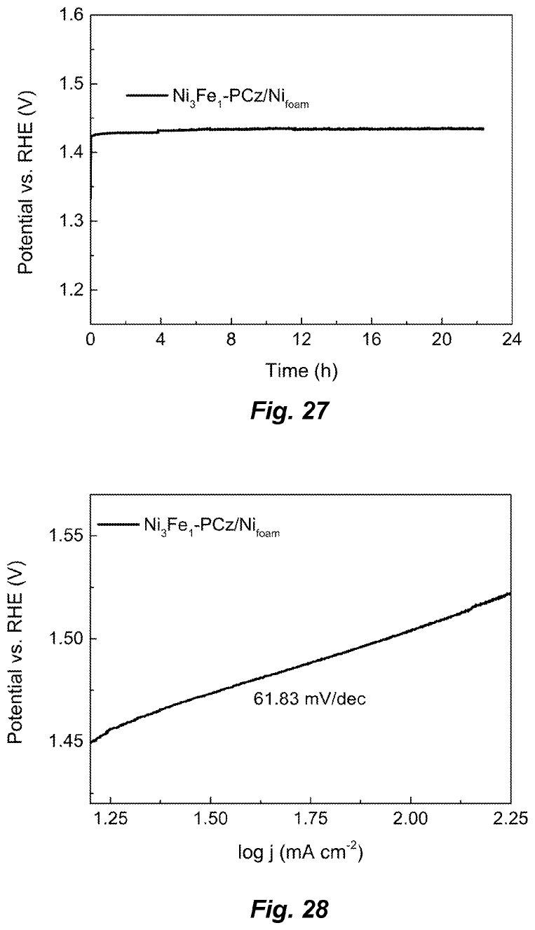

FIG. 6a shows the LSVs for the OER over the Ni₃Fe₁-PCz/Ni_{foam} electrode (1 mV s⁻¹, 1 M KOH, room temperature). To our delight, the Ni₃Fe₁-PCz/Ni_{foam} was substantially more active than Ni₃Fe₁-PCz/CF. Although the onset potentials were similar over the Ni foam and CF-based electrodes, the potential at 10 mA cm⁻² over the Ni₃Fe₁-PCz/Ni_{foam} electrode was very low (~136 mV), despite the overlap with the Ni(II) to Ni(III) oxidation peak. The steady-state overpotential at 10 mA cm⁻² after 22 h was ~200 mV (FIG. 27). This steady-state overpotential is primarily due to the OER, with little overlap by the Ni(II) to Ni(III) peak, and it is very low among the reported earth-abundant catalysts (FIG. 11).

The LSV overpotential at the much higher current density of 100 mA cm⁻² was ~264 mV. At 500 mA cm⁻², the overpotential was 339 mV. The Tafel slope over Ni₃Fe₁-PCz/Ni_{foam} was 61.83 mV dec⁻¹ (FIG. 28), suggesting again that the turnover limiting step is attacked by OH⁻(aq) on a surface oxide. The control electrodes (Ni₃Fe₁/Ni_{foam}, PCz/Ni_{foam}, and Ni_{foam}) possessed little to no OER activity under these conditions. FIG. 6a shows that the OER onset- and overpotentials were much higher over a nickel foam electrode prepared with the same loading of Ni₃Fe₁ using only Nafion as binder, consistent with the comparisons over glassy carbon.

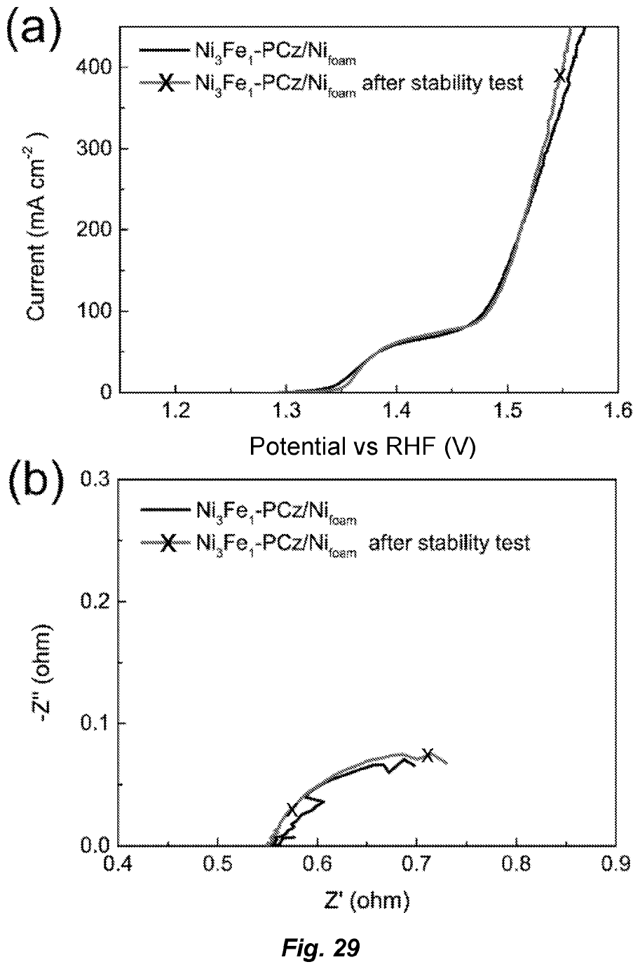

At the much higher galvanostatic current density of 100 mA cm⁻², the overpotential was also essentially constant (−270 mV) over 24 h (FIG. 6b). The LSV recorded afterwards showed a slight increase in performance over that recorded beforehand (FIG. 29a), and the EIS recorded before and after were almost unchanged (FIG. 29b). FIG. 6b also shows that the galvanostatic OER performance was significantly worse over a nickel foam electrode prepared with the same loading of Ni₃Fe₁ using Nafion as binder.

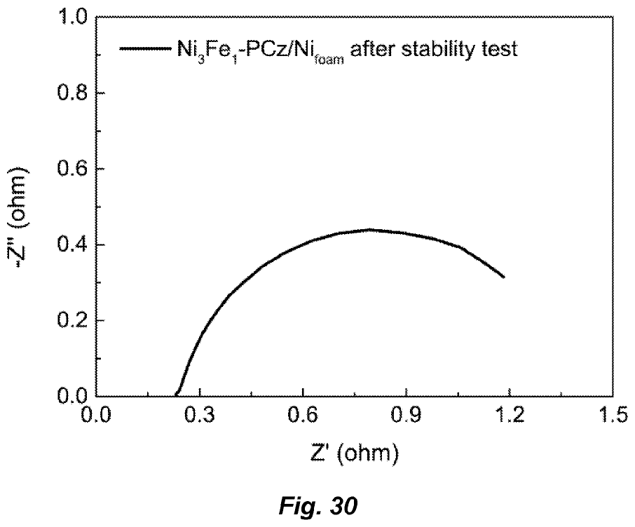

FIGS. 6c and 6d show the galvanostatic OER over the Ni₃Fe₁-PCz/Ni_{foam} electrode under harsh conditions (6 M KOH, 85° C.) at high current density (100 mA cm⁻²) over 120 h. The potential was measured versus the Hg/HgO reference electrode and converted to RHE (FIG. 30). The potential increased by only 0.69% over the first 14.5 h, then stabilized, increasing only 0.61% further during the remaining 105.5 h. The stabilized potential (after 14.5 h) vs. RHE without iR correction was 1.44 V. This is the lowest overpotential vs. RHE and the highest stability that we are aware of for an earth-abundant OER electrode under these harsh conditions. The iR-corrected stabilized potential was 1.42 V (FIG. 6d).

All publications and patents specifically mentioned herein are incorporated by reference for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

While this invention has been described in conjunction with the various exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments according to this invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents of these exemplary embodiments.

1. An electrode comprising an electrically conductive substrate and an electropolymerized carbazole coating, wherein the coating is doped with at least one electrocatalyst.

2. The electrode of claim 1, wherein the electropolymerized carbazole coating comprises polycarbazole (PCz).

3. The electrode of claim 1, wherein the electrocatalyst comprises one or more ions of a first transition metal and one or more ions of a second transition metal.

4. The electrode of claim 3, wherein the one or more ions of the first transition metal are iron.

5. The electrode of claim 4, wherein the one or more ions of iron are iron(II), iron(III), or both iron(II) and iron(III).

6. The electrode of claim 3, wherein the one or more ions of the second transition metal are a period-4 metal.

7. The electrode of claim 6, wherein the one or more ions of the second transition metal are nickel or cobalt.

8. The electrode of claim 6, wherein the one or more ions of the second transition metal have oxidation states of +2, +3, or both +2 and +3.

9. The electrode of claim 6, wherein the one or more ions of the second transition metal are nickel(II), nickel(III), or both nickel(II) and nickel(III).

10. The electrode of claim 3, wherein the first transition metal and the second transition metal have a relative stoichiometric ratio according to formula IA: 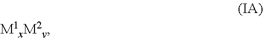
wherein M¹ is an ion of the first transition metal, M² is an ion of the second transition metal, x is 0.01-0.99, and y is 1-x.

11. The electrode of claim 10, wherein Mⁱ is iron, M² is Ni, x is 0.25, and y is 0.75.

12. The electrode of claim 3, wherein the electropolymerized carbazole coating comprises an electrically conductive polymer comprising repeating units of a carbazole monomer, wherein one or more of the repeating units are partially oxidized.

13. The electrode of claim 12, wherein the one or more ions of the first transition metal are iron salts, wherein a nitrogen lone pair of electrons of one carbazole monomer is coordinated to an iron cation of an iron salt, and a nitrogen cation of one oxidized carbazole monomer is paired with an anion of the iron salts; and
wherein the one or more ions of the second transition metal are period-4 transition metal salts, wherein a nitrogen lone pair of electrons of a second carbazole monomer is coordinated to a metal cation of a period-4 transition metal salt, and a nitrogen cation of a second oxidized carbazole monomer is paired with an anion of a period-4 transition metal salt.

14. The electrode of claim 12, wherein the electropolymerized carbazole coating comprises sequential blocks of formula (II): 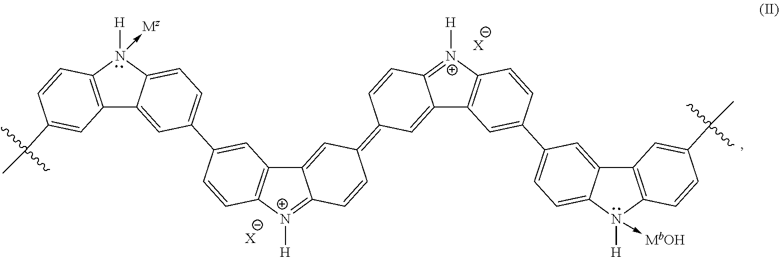
wherein;
each M^{z} is an electrocatalyst; M is an alkali metal; and X⁻ is a counter anion; wherein one or more phenyl rings of the carbazole moieties of the blocks of formula II are optionally substituted.

15. The electrode of claim 14, wherein the electrocatalyst comprises a cation of iron and a cation of nickel or cobalt and wherein X⁻ is OH⁻, O²⁻, or Cl⁻.

16. The electrode of claim 1, wherein the electrically conductive substrate comprises carbon fiber paper (CF), nickel foam (Ni_{foam}), or glassy carbon (GC).

17. The electrode of claim 1, further comprising an alkali base that is paired with the electrically conductive polymer.

18. A method for preparing an electrode according to claim 1, comprising:
a) electropolymerizing carbazole onto an electrically conductive substrate to form an electrocoated polycarbazole substrate;
b) doping the electrocoated polycarbazole substrate in an inert atmosphere with an iron salt and a different period-4 transition metal salt to form a doped polycarbazole substrate, wherein the one or more ions of iron and the one or more ions of another transition metal have a relative stoichiometric ratio according to formula IB: 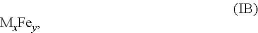
wherein x is 0.01-0.99 and y is 1-x; and
c) oxidizing the doped polycarbazole substrate wherein ions of the iron salt are oxidized from iron(II) to iron(III);
thereby forming the electrode.

19. (canceled)

20. (canceled)

21. (canceled)

22. (canceled)

23. A method for catalytic electrooxidation of water to oxygen comprising:
a) completing an electrical circuit with an electrode of claim 1 as the anode; and
b) contacting the electrical circuit with water.

24. (canceled)

25. An electrode comprising an electrically conductive substrate coated with an electrically conductive polymer, the electrically conductive polymer comprising a plurality of iron cations and a plurality of nickel cations; wherein
a) the electrically conductive polymer comprises repeating units of an optionally substituted carbazole monomer moiety, wherein the repeating units are bonded to each other through an exocyclic covalent bond at a benzo moiety of each internal carbazole monomer moiety, and a plurality of the repeating units are partially oxidized;
b) nitrogen lone pairs of electrons of one or more carbazole monomer moieties are coordinated to iron cations;
c) nitrogen lone pairs of electrons of one or more other carbazole monomer moieties are coordinated to nickel cations;
d) one or more nitrogen cations of oxidized carbazole monomers are paired with anions of iron salts or nickel salts; and
e) the iron cations and nickel cations are present in a ratio of about 1:3.
